(19) United States
(12) Patent Application Publication
(10) Pub. No.: US 2025/0047395 A1
(43) Pub. Date: Feb. 6, 2025

(54) CROSS-LINK INTERFERENCE CONFIGURATION UNDER CHANNEL STATE INFORMATION FRAMEWORK TO SUPPORT MULTIPLE TRANSMISSION RECEPTION POINT OPERATION

(71) Applicant: Qualcomm Incorporated, San Diego, CA (US)

(72) Inventors: Qian ZHANG, Basking Ridge, NJ (US); Yan ZHOU, San Diego, CA (US); Tao LUO, San Diego, CA (US)

(21) Appl. No.: 18/365,162

(22) Filed: Aug. 3, 2023

(51) Int. Cl. H04B 17/345; H04B 7/06; H04W 24/10

(52) U.S. Cl. CPC H04B 17/345; H04B 7/0626; H04B 7/0632; H04W 24/10

(57) ABSTRACT

Various aspects of the present disclosure generally relate to wireless communication. In some aspects, a network node may configure multiple transmission reception point (mTRP) operation in a manner that enables a user equipment (UE) to measure inter-UE cross-link interference (CLI) for each downlink receive beam that corresponds to a respective TRP that communicates with the UE in a duplexing mode with dynamic interference conditions (for example, CLI and/or self-interference). For example, to support mTRP operation, the network node may transmit, to the UE, a CLI configuration that indicates a respective CLI measurement resource set for each TRP that is configured to communicate with the UE, where each CLI measurement resource set may include an interference measurement resource (IMR) set associated with a respective TRP, thereby configuring the UE to measure and report a CLI level for each channel measurement resource (CMR) associated with a TRP that communicates with the UE.

### FIELD OF THE DISCLOSURE

Aspects of the present disclosure generally relate to wireless communication and specifically relate to techniques, apparatuses, and methods associated with a cross-link interference (CLI) configuration under a channel state information (CSI) framework to support multiple transmission reception point (mTRP) operation.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (V2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

In a wireless network, various duplexing configurations may be supported to improve flexibility, spectral efficiency, latency, and/or other important communication parameters. For example, a wireless network may support dynamic time division duplexing (TDD), where an allocation of network resources to uplink and/or downlink communication may be dynamically modified depending on a traffic load. For example, a network node may configure a TDD configuration (for example, a TDD pattern) that includes more uplink transmission time intervals (TTIs) for a UE that has uplink data to transmit, and may configure a TDD configuration with more downlink TTIs when the UE has downlink data to receive. Additionally or alternatively, a network node and/or a UE may be configured to operate in a full-duplexing mode to support concurrent transmission and reception (for example, in the same time resource(s)), which may reduce latency by allowing a downlink transmission to occur in an uplink-only slot and/or by allowing an uplink transmission to occur in a downlink-only slot, enhance spectral efficiency or throughput per cell or per UE, and/or enable more efficient resource utilization by simultaneously utilizing time and frequency resources for downlink and uplink communication. However, dynamic TDD, full-duplexing, and/or other advanced duplexing communication modes may be associated with dynamic interference conditions, including cross-link interference (CLI) and self-interference (SI).

For example, in a dynamic TDD configuration, neighboring network nodes may use different TDD configurations to communicate with served UEs, which may result in a downlink transmission from a first network node to a first UE occurring in the same TTI as an uplink transmission from a second UE to a second network node. In such cases, the concurrent downlink and uplink transmissions may cause CLI, such as downlink-to-uplink interference (sometimes referred to as inter-network node CLI) where the downlink transmission by the first network node interferes with the ability of the second network node to receive the uplink transmission from the second UE. Additionally or alternatively, the concurrent downlink and uplink transmissions may cause uplink-to-downlink interference (sometimes referred to as inter-UE CLI) where the uplink transmission by the second UE interferes with the ability of the first UE to receive the downlink transmission from the first network node. Furthermore, full-duplex communication may be associated with inter-cell CLI, intra-cell CLI, and/or SI when one or more nodes (for example, a network node and/or a UE) transmit and receive in the same TTI. For example, an uplink transmission by a first UE in a cell may interfere with reception of a concurrent downlink transmission by another UE in the cell, thus causing intra-cell inter-UE CLI. In another example, an uplink transmission by a first UE in a first cell may interfere with reception of a downlink transmission by a second UE in a second, thus causing inter-cell inter-UE CLI. Furthermore, SI may occur at any network node or UE that communicates using a full-duplexing configuration, as the transmission of a first signal may interfere with the concurrent reception of a second signal (for example, when the transmitted signal leaks into a receive port and/or when an object in a surrounding environment reflects the transmitted signal back to the receive port).

Accordingly, because there are various duplexing scenarios (for example, dynamic TDD and/or full-duplexing) that may result in a victim UE experiencing inter-cell CLI, intra-cell CLI, SI, and/or other interference that may degrade downlink reception performance, a network node may configure the victim UE to obtain measurements related to the interference experienced at the victim UE and to report the measurements to the network node (for example, to enable the network node to select an appropriate downlink beam, resource allocation, and/or other communication parameters to mitigate the interference experienced at the victim UE). For example, a network node may configure a UE with a static or semi-static periodic measurement resource using Layer 3 (L3) signaling (for example, radio resource control (RRC) messages), and the UE may report the interference measurements to the network node using L3 messages. In general, using L3 signaling to configure the periodic measurement resource and to provide the measurement report that includes the interference measurements may provide a low-complexity solution and low control overhead. However, using static or semi-static RRC signaling lacks flexibility and carries a long latency to report CLI and/or SI.

### SUMMARY

Some aspects described herein relate to a user equipment (UE) for wireless communication. The UE may include a processing system that includes one or more processors and one or more memories coupled with the one or more processors. The processing system may be configured to cause the UE to receive, from a network node, a configuration that indicates a first measurement resource set and a second measurement resource set, wherein the first measurement resource set and the second measurement resource set each include one or more interference measurement resources (IMRs). The processing system may be configured to cause the UE to measure, for each IMR included in the first measurement resource set or the second measurement resource set, a cross-link interference (CLI) level associated with a downlink receive beam associated with one or more of a first transmission reception point (TRP) or a second TRP. The processing system may be configured to cause the UE to transmit, to the network node, a report that includes information related to the CLI level associated with each of the one or more IMRs included in the first measurement resource set and the second measurement resource set.

Some aspects described herein relate to a network node for wireless communication. The network node may include a processing system that includes one or more processors and one or more memories coupled with the one or more processors. The processing system may be configured to cause the network node to transmit, to a UE, a configuration that indicates a first measurement resource set and a second measurement resource set, wherein the first measurement resource set and the second measurement resource set each include one or more IMRs. The processing system may be configured to cause the network node to receive, from the UE, a report that includes information related to a CLI level associated with each of the one or more IMRs included in the first measurement resource set and the second measurement resource set for a first TRP or a second TRP.

Some aspects described herein relate to a method for wireless communication by a UE. The method may include receiving, from a network node, a configuration that indicates a first measurement resource set and a second measurement resource set, wherein the first measurement resource set and the second measurement resource set each include one or more IMRs. The method may include measuring, for each IMR included in the first measurement resource set or the second measurement resource set, a CLI level associated with a downlink receive beam associated with one or more of a first TRP or a second TRP. The method may include transmitting, to the network node, a report that includes information related to the CLI level associated with each of the one or more IMRs included in the first measurement resource set and the second measurement resource set.

Some aspects described herein relate to a method of wireless communication performed by a network node. The method may include transmitting, to a UE, a configuration that indicates a first measurement resource set and a second measurement resource set, wherein the first measurement resource set and the second measurement resource set each include one or more IMRs. The method may include receiving, from the UE, a report that includes information related to a CLI level associated with each of the one or more IMRs included in the first measurement resource set and the second measurement resource set for a first TRP or a second TRP.

Some aspects described herein relate to a non-transitory computer-readable medium that stores a set of instructions for wireless communication. The set of instructions, when executed by one or more processors a UE, may cause the UE to receive, from a network node, a configuration that indicates a first measurement resource set and a second measurement resource set, wherein the first measurement resource set and the second measurement resource set each include one or more IMRs. The set of instructions, when executed by one or more processors a UE, may cause the UE to measure, for each IMR included in the first measurement resource set or the second measurement resource set, a CLI level associated with a downlink receive beam associated with one or more of a first TRP or a second TRP. The set of instructions, when executed by one or more processors a UE, may cause the UE to transmit, to the network node, a report that includes information related to the CLI level associated with each of the one or more IMRs included in the first measurement resource set and the second measurement resource set.

Some aspects described herein relate to a non-transitory computer-readable medium that stores a set of instructions for wireless communication by a network node. The set of instructions, when executed by one or more processors of the network node, may cause the network node to transmit, to a UE, a configuration that indicates a first measurement resource set and a second measurement resource set, wherein the first measurement resource set and the second measurement resource set each include one or more IMRs. The set of instructions, when executed by one or more processors of the network node, may cause the network node to receive, from the UE, a report that includes information related to a CLI level associated with each of the one or more IMRs included in the first measurement resource set and the second measurement resource set for a first TRP or a second TRP.

Some aspects described herein relate to an apparatus for wireless communication. The apparatus may include means for receiving, from a network node, a configuration that indicates a first measurement resource set and a second measurement resource set, wherein the first measurement resource set and the second measurement resource set each include one or more IMRs. The apparatus may include means for measuring, for each IMR included in the first measurement resource set or the second measurement resource set, a CLI level associated with a downlink receive beam associated with one or more of a first TRP or a second TRP. The apparatus may include means for transmitting, to the network node, a report that includes information related to the CLI level associated with each of the one or more IMRs included in the first measurement resource set and the second measurement resource set.

Some aspects described herein relate to an apparatus for wireless communication. The apparatus may include means for transmitting, to a UE, a configuration that indicates a first measurement resource set and a second measurement resource set, wherein the first measurement resource set and the second measurement resource set each include one or more IMRs. The apparatus may include means for receiving, from the UE, a report that includes information related to a CLI level associated with each of the one or more IMRs included in the first measurement resource set and the second measurement resource set for a first TRP or a second TRP.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating examples of full-duplex communication in a wireless network in accordance with the present disclosure.

FIG. 4 is a diagram illustrating examples of full-duplex deployment scenarios in which cross-link interference (CLI) and/or self-interference (SI) may occur in accordance with the present disclosure.

FIG. 5 is a diagram illustrating examples of different duplexing modes in accordance with the present disclosure.

FIGS. 6A-6B are diagrams illustrating examples of inter-cell CLI and intra-cell CLI that may occur in dynamic time division duplexing (TDD) and/or full-duplex deployment scenarios in accordance with the present disclosure.

FIG. 7 is a diagram illustrating examples associated with a CLI configuration under a channel state information (CSI) framework to support multiple transmission reception point (mTRP) operation in accordance with the present disclosure.

FIG. 8 is a flowchart illustrating an example process performed, for example, by a UE in accordance with the present disclosure.

FIG. 9 is a flowchart illustrating an example process performed, for example, by a network node in accordance with the present disclosure.

FIGS. 10-11 are diagram of example apparatuses for wireless communication in accordance with the present disclosure.

### DETAILED DESCRIPTION

Various aspects of the present disclosure are described hereinafter with reference to the accompanying drawings. However, aspects of the present disclosure May be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to a cross-link interference (CLI) configuration under a channel state information (CSI) framework to support multiple transmission reception point (mTRP) operation. Some aspects more specifically relate to techniques to configure mTRP operation in a manner that enables a user equipment (UE) to measure inter-UE CLI for each downlink receive beam that corresponds to a respective TRP that communicates with the UE in a sub-band full-duplexing (SBFD) mode, an in-band full-duplexing (IBFD) mode, a dynamic time division duplexing (TDD) mode, and/or another suitable mode that may be subject to intra-cell CLI, inter-cell CLI, self-interference (SI), and/or other dynamic interference conditions. For example, to support or otherwise enable mTRP operation, a network node may transmit, and a UE may receive, a CLI configuration that indicates a respective CLI measurement resource set for each TRP that is configured to communicate with the UE, where each CLI measurement resource set may include an interference measurement resource (IMR) set associated with a respective TRP, thereby configuring the UE to measure and report a CLI level for each channel measurement resource (CMR) (for example, a non-zero power (NZP) CMR) that is associated with a TRP that communicates with the UE in an mTRP mode.

Additionally or alternatively, in cases where different TRPs communicate with the UE using a relatively wider beam that shares a spatial receive (Rx) parameter (for example, associated with a quasi co-location (QCL) Type D relationship, or a qcl-TypeD parameter), the CLI configuration provided to the UE may indicate one IMR that can be used to measure the common (wider) Rx beam on one or more panels of the UE for the respective TRPs. For example, in some aspects, the CLI configuration may generally include multiple groups of resource sets, where each resource set includes one or more CMRs and one or more CLI IMRs associated with the one or more CMRs, where the CLI IMRs in each resource set may be associated with one or more aggressor UEs and/or one or more transmit (Tx) beams of the one or more aggressor UEs (for example, UEs that are causing intra-cell or inter-cell CLI). In addition, as described herein, some aspects may relate to different mappings between the CMRs and the CLI IMRs included in the respective resource sets (for example, a quantity of CMRs in each resource set may be less than, equal to, or greater than a quantity of CLI IMRs in the same resource set depending on a use case associated with the mTRP operation), techniques for reporting the CLI level to support mTRP operation, and/or hypotheses that may be configured for the UE to report the CLI level to support mTRP operation, among other examples.

Particular aspects of the subject matter described in this disclosure can be implemented to realize one or more of the following potential advantages. In some examples, the described techniques can be used to enable CLI measurement and reporting using a CSI framework such that CLI measurements can be configured for a UE and/or reported by the UE using Layer 1 (L1) signaling, such as downlink control information (DCI) and/or uplink control information (UCI), and/or using Layer 2 (L2) signaling, such as a medium access control (MAC) control element (MAC-CE). In this way, a victim UE that is communicating in a dynamic TDD scenario or a full-duplexing scenario and experiencing inter-UE CLI by an aggressor UE can measure and report the inter-UE CLI using L1/L2 signaling, which can be optimized for short-term interference measurements and/or lower latency (for example, relative to a Layer 3 (L3) framework), and/or may enable the network node to adjust UE scheduling to reduce or mitigate inter-UE CLI.

Multiple-access radio access technologies (RATs) have been adopted in various telecommunication standards to provide common protocols that enable different wireless communication devices to communicate on a municipal, national, regional, or global level. For example, New Radio (NR), also be referred to as 5G, is part of a continuous mobile broadband evolution promulgated by the Third Generation Partnership Project (3GPP) to better support Internet of things (IoT) and reduced capability (RedCap) device deployments, industrial connectivity, millimeter wave (mmWave) expansion, licensed and unlicensed spectrum access, non-terrestrial network (NTN) deployment, sidelink and other device-to-device direct communication technologies, massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other RATs such as 6G may be introduced, to further advance mobile broadband evolution (for example, to support full-duplexing or other advanced duplexing schemes, artificial intelligence or machine learning, cooperative communications, massive and ambient IoT, enhanced modulation and coding, new frequency bands, overlapping spectrum use, and extended reality (XR), among other examples).

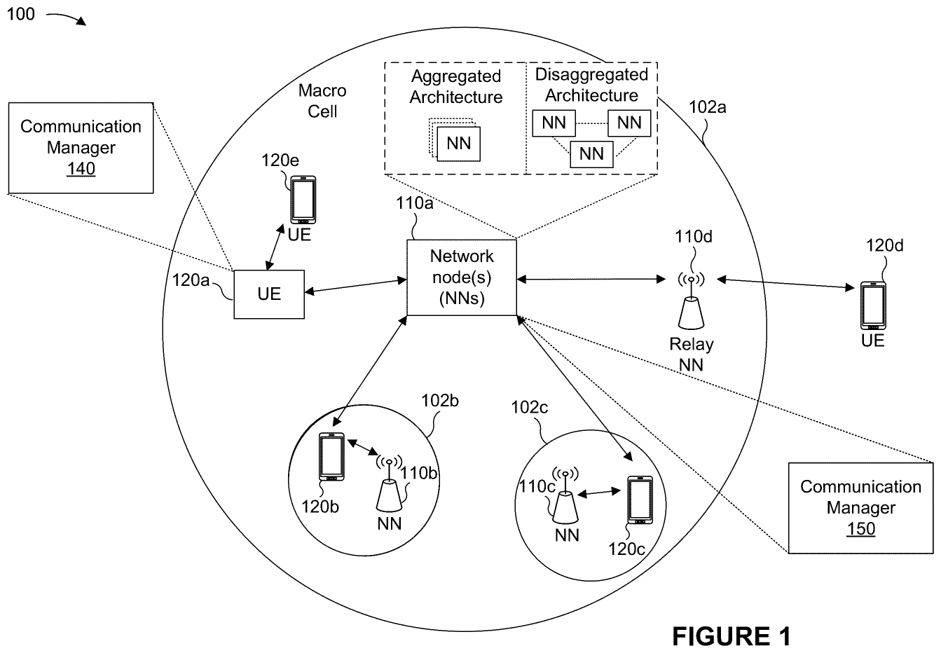

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110 (also referred to as network entities), shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

A network node 110 may include one or more devices or systems that enable communication between a UE 120 and one or more components of the wireless communication network 100. A network node 110 may be, may include, or may be referred to as, an NR network node, a 5G network node, a 6G network node, a Node B, an eNB (for example, in 4G), a gNB (for example, in 5G), an access point (AP), a transmission reception point (TRP), a mobility element of a network, a core network node, a network element, a network equipment, and/or another type of device or devices included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full protocol stack (such as a full gNB protocol stack), or a collection of devices or systems that collectively implement the full protocol stack. For example, and as shown, a network node 110 may be an aggregated network node, meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may use a protocol stack that is physically distributed and/or logically distributed among two or more nodes in the same geographic location or in different geographic locations. In some deployments, disaggregated network nodes 110 may be used in an integrated access and backhaul (IAB) network, in an open radio access network (O-RAN), such as the network configuration sponsored by the O-RAN Alliance, or in a virtualized radio access network (vRAN), also known as a cloud radio access network (C-RAN), to facilitate scaling of communication systems by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a MAC layer, and/or one or more high physical (PHY) layers depending, at least in part, on a functional split, such as a functional split defined by the 3GPP. In some examples, a DU also may host one or more low PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or low PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve TDD, in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UE 120 and the network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT). Furthermore, in a wireless local area network (WLAN), one or more APs and one or more stations (STAs) that include multiple antennas also may support spatial multiplexing, which may be used to increase the spectral efficiency and the resultant throughput of a transmission. To implement spatial multiplexing, the transmitting device divides the data stream into a quantity of separate, independent spatial streams that are then separately encoded and transmitted in parallel via the multiple transmit antennas.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The IAB donor 110 may connect to the core network via a wired backhaul link. For example, an Ng interface of the IAB donor 110 may terminate at the core network. Additionally or alternatively, an IAB donor 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each IAB node 110 may communicate directly with the IAB donor 110 via a wireless backhaul link to access the core network, or may communicate indirectly with the IAB donor 110 via one or more other IAB nodes 110 and associated wireless backhaul links that form a backhaul path to the core network. Some IAB donors 110 or other IAB nodes 110 may also communicate directly with one or more UEs 120 via wireless access links that carry access traffic. In some examples, network resources for wireless communication (such as time resources, frequency resources, and/or spatial resources) may be shared between access links and backhaul links.

An IAB donor 110 may include a CU, which may perform access node controller (ANC) functions and/or AMF functions. The CU may configure a DU of the IAB donor 110 and/or may configure one or more IAB nodes 110 (for example, a mobile termination (MT) function and/or a DU function of each of the IAB nodes) that connect to the core network via the IAB donor 110. Thus, a CU of an IAB donor 110 may control and/or configure the entire IAB network (or a portion thereof) that connects to the core network via the IAB donor 110, such as by using control messages and/or configuration messages (for example, an RRC configuration message or an F1 application protocol (F1AP) message).

An IAB node 110 other than an IAB donor 110 also may control and/or schedule communications for a second IAB node 110 (for example, when the IAB node provides DU functions for the MT functions of the second IAB node). In such deployments, the first IAB node 110 may be referred to as a parent IAB node of the second IAB node 110, and the second IAB node 110 may be referred to as a child IAB node of the first IAB node 110. Similarly, a child IAB node of the second IAB node 110 may be referred to as a grandchild IAB node of the first IAB node 110. A DU function of a parent IAB node may control and/or schedule communications for child IAB nodes of the parent IAB node. In some examples, a DU function may exercise limited control over communications of a grandchild node, such as via indication of soft resources or restricted beams at a child node associated with the grandchild node. In some examples, an IAB node 110 that implements a DU function may be referred to as a scheduling node or a scheduling component, and an IAB node 110 that implements an MT function may be referred to as a scheduled node or a scheduled component.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

In some examples, a relay network node 110 may include an electromagnetic radiation reflective component that can be used to relay (for example, reflect) signals from a first other network node 110 to a second other network node 110 or a UE 120. Such a relay network node 110 can include, for example, a radio frequency reflection array configured to perform radio frequency reflection functions. The electromagnetic radiation reflective array can be, for example, a reconfigurable intelligent surface (RIS) (which also can be referred to as an intelligent reflective surface (IRS)).

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 may include or may be included in a housing that houses components associated with the UE 120, such as one or more processor components and/or one or more memory components. One or more of the processor components may be coupled with one or more of the memory components and/or other components. For example, the processor components (for example, one or more processors) and the memory components (for UEample, one or more memories) may be operatively coupled, communicatively coupled, electronically coupled, or electrically coupled with one another. In some examples, a UE 120 include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE. 5G, or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

Some UEs 120 may be considered machine-type communication (MTC) or evolved or enhanced machine-type communication (eMTC) UEs (or further enhanced cMTC (feMTC), or enhanced feMTC (efeMTC), or further evolutions thereof, all of which may be simply referred to as “MTC”). An MTC UE may be, may include, or may be included in or coupled with a robot, an unmanned aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may communicate using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

Downlink and uplink resources may include time domain resources (frames, subframes, slots, and/or symbols), frequency domain resources (frequency bands, frequency carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As indicated above, a BWP may be configured as a subset or a part of a total or full component carrier bandwidth and generally forms or encompasses a set of contiguous common resource blocks (CRBs) within the full component carrier bandwidth. In other words, within the carrier bandwidth, a BWP starts at a CRB and may span a set of consecutive CRBs. Each BWP may be associated with its own numerology (indicating a sub-carrier spacing (SCS) and cyclic prefix (CP)). A UE 120 may be configured with up to four downlink BWPs and up to four uplink BWPs for each serving cell. To enable reasonable UE battery consumption, only one BWP in the downlink and one BWP in the uplink are generally active at a given time on an active serving cell under typical operation. The active BWP defines the operating bandwidth of the UE 120 within the operating bandwidth of the serving cell while all other BWPs with which the UE 120 is configured are deactivated. On deactivated BWPs, the UE 120 does not transmit or receive any communications.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHZ through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FRI is often referred to (interchangeably) as a “Sub-6 GHz” band in some documents and articles. Similarly. FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FRI or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHZ. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

In some aspects, the UE 120 may include a communication manager 140. As described in more detail elsewhere herein, the communication manager 140 may receive, from a network node, a configuration that indicates a first measurement resource set and a second measurement resource set, wherein the first measurement resource set and the second measurement resource set each include one or more IMRs; measure, for each IMR included in the first measurement resource set or the second measurement resource set, a CLI level associated with a downlink receive beam associated with one or more of a first TRP or a second TRP; and transmit, to the network node, a report that includes information related to the CLI level associated with each of the one or more IMRs included in the first measurement resource set and the second measurement resource set. Additionally or alternatively, the communication manager 140 may perform one or more other operations described herein.

In some aspects, the network node 110 may include a communication manager 150. As described in more detail elsewhere herein, the communication manager 150 may transmit, to a UE, a configuration that indicates a first measurement resource set and a second measurement resource set, wherein the first measurement resource set and the second measurement resource set each include one or more IMRs; and receive, from the UE, a report that includes information related to a CLI level associated with each of the one or more IMRs included in the first measurement resource set and the second measurement resource set for a first TRP or a second TRP. Additionally or alternatively, the communication manager 150 may perform one or more other operations described herein.

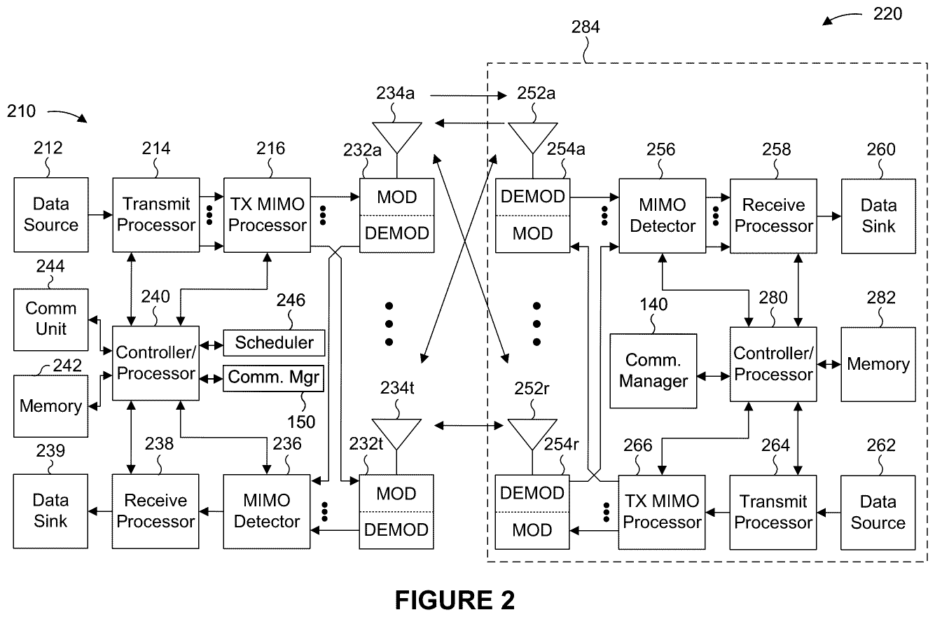

FIG. 2 is a diagram illustrating an example network node 210 in communication with an example UE 220 in a wireless network in accordance with the present disclosure. The network node 210 of FIG. 2 may be an example of the network node 110 described with reference to FIG. 1. Similarly, the UE 220 may be an example of the UE 120 described with reference to FIG. 1.

As shown in FIG. 2, the network node 210 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150 among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 210. The transceiver may be under control of and used by a processor, such as the controller/processor 240, and in some aspects in conjunction with processor-readable code stored in the memory 242, to perform aspects of the methods, processes, and/or operations described herein. In some aspects, the network node 210 may include one or more interfaces, communication components, and/or other components that facilitate communication with the UE 220 or another network node.

The terms “processor,” “controller,” or “controller/processor” may refer to one or more controllers and/or one or more processors. For example, reference to “a/the processor” or “a/the controller/processor” (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 210 may include transmit processor 214, TX MIMO processor 216, MIMO detector 236, receive processor 238, and/or controller/processor 240. Similarly, one or more processors of the UE 220 may include MIMO detector 256, receive processor 258, transmit processor 264, TX MIMO processor 266, and/or controller/processor 280. As used herein, “processor,” “controller,” or “controller/processor” can refer to a general purpose processor, a DSP, an ASIC, an FPGA or other PLD, discrete gate or transistor logic, discrete hardware components, or any combination thereof. A general purpose processor may be a microprocessor or any commercially available processor, controller, microcontroller, or state machine. A processor may also be implemented as a combination of computing devices (for example, a combination of a DSP and a microprocessor, a plurality of microprocessors, one or more microprocessors in conjunction with a DSP core, a system on a chip (SoC), or any other such configuration).

In some aspects, a single processor may perform all of the operations described as being performed by the one or more processors. In some aspects, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

For downlink communication from the network node 210 to the UE 220, the transmit processor 214 may receive data (“downlink data”) intended for the UE 220 (or a set of UEs that includes the UE 220) from the data source 212 (such as a data pipeline or a data queue). In some examples, the transmit processor 214 may select one or more MCSs for the UE 220 in accordance with one or more channel quality indicators (CQIs) received from the UE 220. The network node 210 may process the data (for example, including encoding the data) for transmission to the UE 220 on a downlink in accordance with the MCS(s) selected for the UE 220 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a CSI reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC-CE communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 220 to the network node 210, uplink signals from the UE 220 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 210 may use the scheduler 246 to schedule one or more UEs 220 for downlink or uplink communications. In some aspects, the scheduler 246 may use DCI to dynamically schedule DL transmissions to the UE 220 and/or UL transmissions from the UE 220. In some examples, the scheduler 246 may allocate recurring time domain resources and/or frequency domain resources that the UE 220 may use to transmit and/or receive communications using an RRC configuration (for example, a semi-static configuration), for example, to perform semi-persistent scheduling (SPS) or to configure a configured grant (CG) for the UE 220.

One or more of the transmit processor 214, the TX MIMO processor 216, the modem 232, the antenna 234, the MIMO detector 236, the receive processor 238, and/or the controller/processor 240 may be included in an RF chain of the network node 210. An RF chain may include filters, mixers, oscillators, amplifiers, analog-to-digital converters (ADCs), and/or other devices that convert between an analog signal (such as for transmission or reception via an air interface) and a digital signal (such as for processing by one or more processors of the network node 210). In some aspects, the RF chain may be or may be included in a transceiver of the network node 210.

In some examples, the network node 210 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 210 may use the communication unit 244 to transmit and/or receive data associated with the UE 220 or to perform network control signaling, among other examples. The communication unit 244 may include a transceiver and/or an interface, such as a network interface.

The UE 220 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, and/or a memory 282, among other examples. One or more of the components of the UE 220 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 220. The transceiver may be under control of and used by a processor, such as the controller/processor 280, and in some aspects in conjunction with processor-readable code stored in the memory 282, to perform aspects of the methods, processes, or operations described herein. In some aspects, the UE 220 may include another interface, another communication component, and/or another component that facilitates communication with the network node 210 and/or another UE 220.

For downlink communication from the network node 210 to the UE 220, the set of antennas 252 may receive the downlink communications or signals from the network node 210 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 220 to the data sink 260 (such as a data pipeline, a data queue, and/or an application executed on the UE 220), and may provide decoded control information and system information to the controller/processor 280.

For uplink communication from the UE 220 to the network node 210, the transmit processor 264 may receive and process data (“uplink data”) from a data source 262 (such as a data pipeline, a data queue, and/or an application executed on the UE 220) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 210 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 220 by the network node 210.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, R output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254r may transmit a set of uplink signals (for example, R uplink signals) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 220) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. The term “beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 220 or network nodes 110 may include different numbers of antenna elements. For example, a UE 220 may include a single antenna element, two antenna elements, four antenna elements, eight antenna elements, or a different number of antenna elements. As another example, a network node 210 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

The network node 210 may provide the UE 220 with a configuration of transmission configuration indicator (TCI) states that indicate or correspond to beams that may be used by the UE 220, such as for receiving one or more communications via a physical channel. For example, the network node 210 may indicate (for example, using DCI) an activated TCI state to the UE 220, which the UE 220 may use to generate a beam for receiving one or more communications via the physical channel. A beam indication may be, or may include, a TCI state information element, a beam identifier (ID), spatial relation information, a TCI state ID, a closed loop index, a panel ID, a TRP ID, and/or an SRS set ID, among other examples. A TCI state information element (sometimes referred to as a TCI state herein) may indicate particular information associated with a beam. For example, the TCI state information element may indicate a TCI state identification (for example, a tci-StateID), a QCL type (for example, a qcl-Type1, qcl-Type2, qcl-TypeA, qcl-TypeB, qcl-TypeC, or a qcl-TypeD, among other examples), a cell identification (for example, a ServCellIndex), a bandwidth part identification (bwp-Id), or a reference signal identification, such as a CSI-RS identification (for example, an NZP-CSI-RS-ResourceId or an SSB-Index, among other examples). Spatial relation information may similarly indicate information associated with an uplink beam. The beam indication may be a joint or separate DL/UL beam indication in a unified TCI framework. In a unified TCI framework, the network may support common TCI state ID update and activation, which may provide common QCL and/or common UL transmission spatial filters across a set of configured component carriers. This type of beam indication may apply to intra-band CA, as well as to joint DL/UL and separate DL/UL beam indications. The common TCI state ID may imply that one reference signal determined according to the TCI state(s) indicated by a common TCI state ID is used to provide QCL Type-D indication and to determine UL transmission spatial filters across the set of configured CCs.

In some examples, the network may support an L1-based beam indication using at least UE-specific (unicast) DCI to indicate joint or separate DL/UL beam indications that may be selected from active TCI states. In some examples, DCI formats 1_1 and/or 1_2 may be used for beam indication. The network node 210 may include a support mechanism for the UE 220 to acknowledge successful decoding of a beam indication. For example, the acknowledgment/negative acknowledgment of the PDSCH scheduled by the DCI carrying the beam indication may also be used as an acknowledgement for the DCI.

Further efficiencies in throughput, signal strength, and/or other signal properties may be achieved through beam refinement. For example, the network node 210 may be capable of communicating with the UE 220 using beams of various beam widths. For example, the network node 210 may be configured to utilize a wider beam to communicate with the UE 220 when the UE 220 is in motion because wider coverage may increase the likelihood that the UE 220 remains in coverage of the network node 210 while moving. Conversely, the network node 210 may use a narrower beam to communicate with the UE 220 when the UE 220 is stationary because the network node 210 can reliably focus coverage on the UE 220 with low or minimal likelihood of the UE 220 moving out of the coverage area of the network node 210. In some examples, to select a particular beam for communication with a UE 220, the network node 210 may transmit a reference signal, such as a synchronization signal block (SSB) or a CSI-RS, on each of a plurality of beams in a beam-sweeping manner. In some examples, SSBs may be transmitted on wider beams, whereas CSI-RSs may be transmitted on narrower beams. The UE 220 may measure the RSRP or the signal-to-interference-plus-noise ratio (SINR) on each of the beams and transmit a beam measurement report (for example, an L1 measurement report) to the network node 210 indicating the RSRP or SINR associated with each of one or more of the measured beams. The network node 210 may then select the particular beam for communication with the UE 220 based on the L1 measurement report. In some other examples, when there is channel reciprocity between the uplink and the downlink, the network node 210 may derive the particular beam to communicate with the UE 220 (for example, on both the uplink and downlink) based on uplink measurements of one or more uplink reference signals, such as an SRS, transmitted by the UE 220.

One enhancement for multi-beam operation at higher carrier frequencies is facilitation of efficient (for example, low latency and low overhead) downlink and/or uplink beam management operations to support higher Layer 1 and/or Layer 2 (L1/L2)-centric inter-cell mobility. L1 and/or L2 signaling may be referred to as “lower layer” signaling and may be used to activate and/or deactivate candidate cells in a set of cells configured for L1/L2 mobility and/or to provide reference signals for measurement by the UE 220, by which the UE 220 may select a candidate beam as a target beam for a lower layer handover operation. Accordingly, one goal for L1/L2-centric inter-cell mobility is to enable a UE to perform a cell switch via dynamic control signaling at lower layers (for example, DCI for L1 signaling or a MAC-CE for L2 signaling), rather than semi-static L3 RRC signaling, in order to reduce latency, reduce overhead, and/or otherwise increase efficiency of the cell switch.

In some examples, for a UE 220, UL transmission may be performed using one antenna panel, and DL reception may be performed using another antenna panel. In some examples, full-duplex communication may be conditional on a beam separation of the UL beam and DL beam at respective antenna panels. Utilizing full-duplex communication may provide a reduction in latency, such that it may be possible to receive a DL signal in UL-only slots, which may enable latency savings. In addition, full-duplex communication may enhance spectrum efficiency per cell or per UE 220, and may enable more efficient utilization of resources. Beam separation of the UL and DL beams assists in limiting or reducing self-interference that may occur during full-duplex communication. UL and DL beams that are separated on their respective antenna panels may provide reliable full-duplex communication by minimizing or reducing self-interference.

A full-duplex UE 220 may perform a self-interference measurement (SIM) procedure to identify self-interference from transmissions of the full-duplex UE 220. A full-duplex network node 210 also may perform a SIM procedure to identify self-interference from transmissions of the full-duplex network node 210. The UE 220 may provide a measurement report to the network node 210 to indicate results of the UE SIM. The network node 210 may select pairs of beams (referred to herein as “beam pairs”) for the UE 220 (“UE beam pairs”) and the network node 210 (“network node beam pairs”) to use during full-duplex communications. A beam pair generally includes an Rx beam and a Tx beam, such as a DL beam and an UL beam, respectively, for the UE 220, and similarly, an UL beam and a DL beam, respectively, for the network node 210.

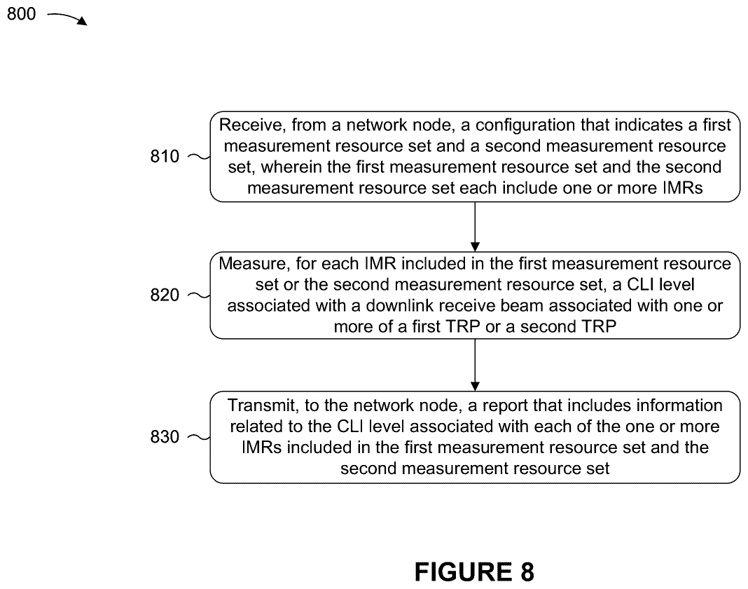

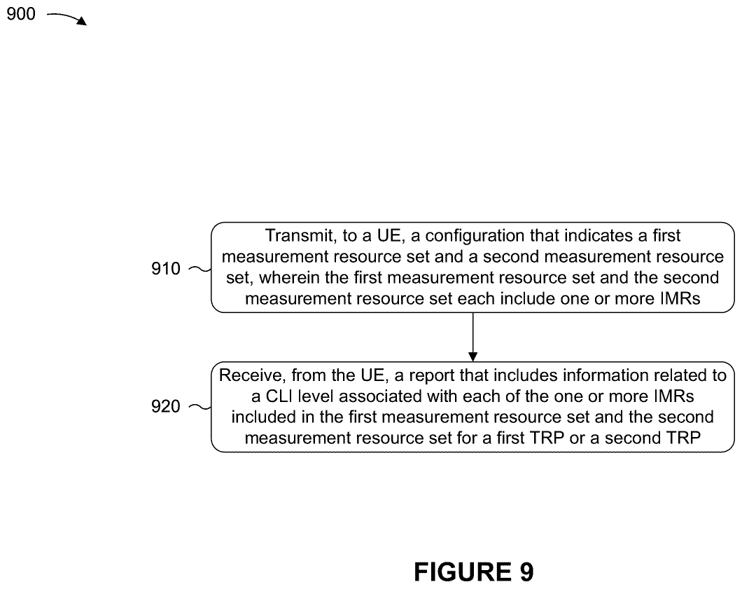

The network node 110, the controller/processor 240 of the network node 210, the UE 120, the controller/processor 280 of the UE 220, or any other component(s) of FIG. 1 or 2 may implement one or more techniques or perform one or more operations associated with a CLI configuration under a CSI framework to support mTRP operation, as described in more detail elsewhere herein. For example, the controller/processor 240 of the network node 210, the controller/processor 280 of the UE 220, any other component(s) of FIG. 2 may perform or direct operations of, for example, process 800 of FIG. 8, process 900 of FIG. 9, or other processes as described herein (alone or in conjunction with one or more other processors). The memory 242 may store data and program codes for the network node 110 or the network node 210. The memory 282 May store data and program codes for the UE 120 or the UE 220. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 210 or the UE 220 may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, the UE 220 includes means for receiving, from a network node 210, a configuration that indicates a first measurement resource set and a second measurement resource set, wherein the first measurement resource set and the second measurement resource set each include one or more IMRs; means for measuring, for each IMR included in the first measurement resource set or the second measurement resource set, a CLI level associated with a downlink receive beam associated with one or more of a first TRP or a second TRP; and/or means for transmitting, to the network node 210, a report that includes information related to the CLI level associated with each of the one or more IMRs included in the first measurement resource set and the second measurement resource set. The means for the UE 220 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 210 includes means for transmitting, to a UE 220, a configuration that indicates a first measurement resource set and a second measurement resource set, wherein the first measurement resource set and the second measurement resource set each include one or more IMRs; and/or means for receiving, from the UE 220, a report that includes information related to a CLI level associated with each of the one or more IMRs included in the first measurement resource set and the second measurement resource set for a first TRP or a second TRP. The means for the network node 210 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

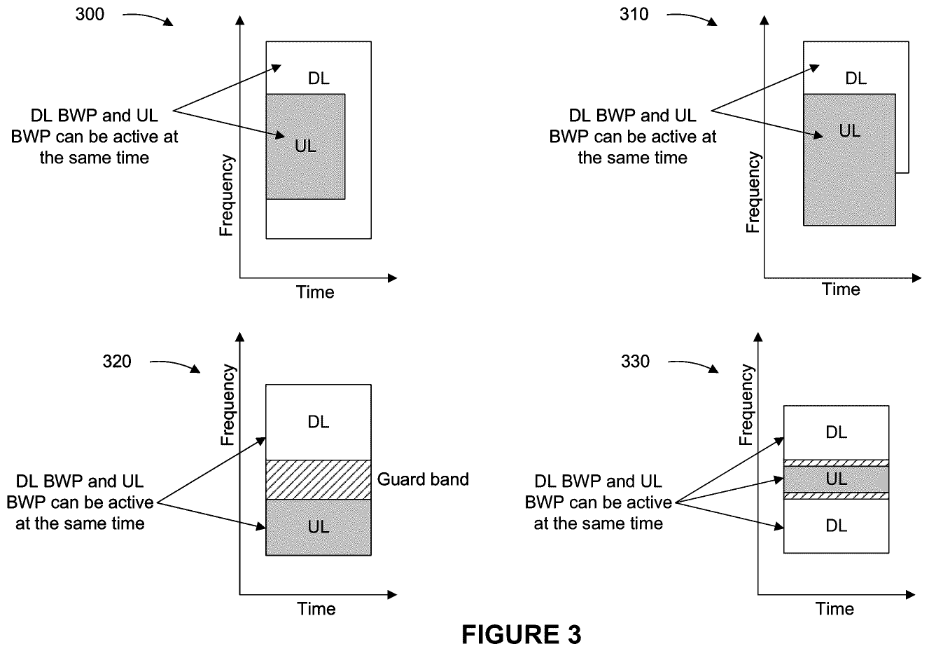

FIG. 3 is a diagram illustrating examples 300, 310, 320, 330 of full-duplex communication in a wireless network in accordance with the present disclosure. As described herein, “full-duplex communication” generally refers to simultaneous uplink and downlink communication in a wireless network, which may be a capability of a UE, a network node, or another suitable device. For example, a UE operating in a full-duplex mode may transmit an uplink communication and receive a downlink communication at the same time (for example, in the same slot or the same symbol) and/or a network node operating in a full-duplex mode may receive an uplink communication and transmit a downlink communication at the same time. “Half-duplex communication” in a wireless network generally refers to unidirectional communications (for example, only downlink communication or only uplink communication) at a given time (for example, a device only transmits or only receives in a given slot or a given symbol).

As shown in FIG. 3, examples 300 and 310 show examples of IBFD communication. In an IBFD communication scenario, a UE may transmit an uplink communication to a network node and receive a downlink communication from the network node on the same time and frequency resources. As shown in example 300, in a first example of IBFD, the time and frequency resources for uplink communication may fully overlap with the time and frequency resources for downlink communication (for example, all time and frequency resources allocated to uplink communication are also available for downlink communication). As shown in example 310, in a second example of IBFD, the time and frequency resources for uplink communication may partially overlap with the time and frequency resources for downlink communication (for example, some time and frequency resources are reserved for uplink communication only).

As further shown in FIG. 3, examples 320 and 330 show SBFD communication, which may also be referred to as “sub-band frequency division duplex (SBFDD),” “flexible duplex,” or “(FDD in unpaired spectrum.” In an SBFD configuration, a UE may transmit an uplink communication to a network node and receive a downlink communication from the network node at the same time, but on different frequency resources. For example, the different frequency resources may be sub-bands of a frequency band, such as a TDD band. In such examples, the frequency resources used for downlink communication may be separated from the frequency resources used for uplink communication, in the frequency domain, by a guard band. For example, as shown by example 320, an SBFD configuration may include a downlink bandwidth part and an uplink bandwidth part that can be active at the same time, where a guard band separates the downlink bandwidth part and the uplink bandwidth (for example, to prevent interference). Additionally or alternatively, as shown by example 330, an SBFD configuration may include a first downlink bandwidth part, a second downlink bandwidth part, and an uplink bandwidth part provided between the first downlink bandwidth part and the second downlink bandwidth part, with a first guard band separating the uplink bandwidth part from the first downlink bandwidth part and a second guard band separating the uplink bandwidth part from the second downlink bandwidth part.

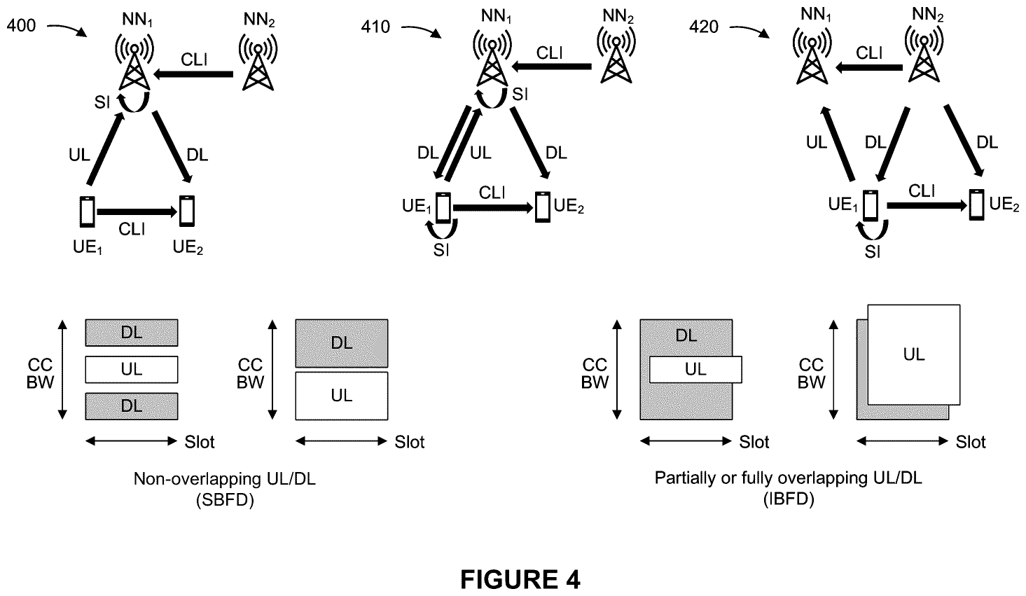

FIG. 4 is a diagram illustrating examples 400, 410, 420 of full-duplex deployment scenarios in which CLI and/or SI may occur in accordance with the present disclosure. As shown in FIG. 4, examples 400, 410, 420 include one or more UEs in communication with one or more network nodes in a wireless network that supports full-duplex communication. In general, as described herein, utilizing a full-duplexing communication mode may provide reduced latency by allowing a downlink transmission to occur in an uplink-only slot and/or by allowing an uplink transmission to occur in a downlink-only slot. In addition, full-duplex communication may enhance spectral efficiency or throughput per cell or per UE and/or enable more efficient resource utilization by simultaneously utilizing time and frequency resources for downlink and uplink communication. However, as described in further detail herein, full-duplexing communication modes may be associated with dynamic interference conditions.

For example, as shown in FIG. 4, example 400 includes a first UE (shown as UE₁) and a second UE (shown as UE₂) in communication with a first network node (shown as NN₁) operating in a full-duplexing mode, with the first UE and the second UE operating in a half-duplexing mode. For example, as shown in FIG. 4, the first UE may transmit one or more uplink transmissions to the first network node, and the second UE may concurrently receive one or more downlink transmissions from the first network node. Accordingly, in example 400, the first network node is operating in a full-duplexing mode, and the first UE and the second UE are each operating in a half-duplexing mode. As shown by example 400, there may be various forms of interference that may degrade downlink reception performance at one or more UEs and/or uplink reception performance at the first network node operating in the full-duplexing mode.

For example, as shown, the first network node may experience inter-cell CLI caused by downlink transmissions from a second network node (shown as NN₂) that may be located in an adjacent or nearby cell. Furthermore, as shown, the uplink transmission from the first UE to the first network node may cause intra-cell CLI at the second UE (for example, CLI that interferes with downlink reception at the second UE). Furthermore, as shown, the first network node may experience self-interference, where the downlink transmission to the second UE interferes with reception of the uplink transmission from the first UE. For example, as described herein, self-interference may generally occur when a transmitted signal leaks into a receive port and/or when an object in a surrounding environment reflects a transmitted signal back to a receive port (for example, causing a clutter echo effect), thus interfering with reception of a desired signal at the receive port. In general, the full-duplexing mode used by the first network node in example 400 may be an SBFD mode, where a component carrier bandwidth is divided into non-overlapping uplink and downlink sub-bands.

As further shown in FIG. 4, in example 410, a first UE may communicate with a first network node in a full-duplexing mode. For example, in example 410, the first UE may receive one or more downlink transmissions from the first network node, and the first UE may concurrently transmit one or more uplink transmissions to the first network node. Accordingly, in example 410, the first network node and the first UE are both operating in a full-duplexing mode. Furthermore, as shown, the first network node may be communicating with a second UE operating in a half-duplex mode. As shown in FIG. 4, the first UE may experience self-interference, where the uplink transmission to the first network node interferes with reception of the downlink transmission from the first network node, and the first UE may cause cross-link interference at the second UE, where the uplink transmission to the first network node interferes with downlink reception at the second UE. Additionally, in example 410, the first network node may experience inter-cell CLI caused by one or more downlink transmissions from a second network node interfering with reception of the uplink transmission from the first UE, and the first network node may experience self-interference, where downlink transmission(s) to the first UE and/or the second UE interferes with reception of the uplink transmission from the first UE. In example 410, the full-duplex communication may be performed in an SBFD mode, where a component carrier bandwidth is divided into non-overlapping uplink and downlink sub-bands, or in an IBFD mode, where uplink and downlink resources fully or partially overlap.

As further shown in FIG. 4, in example 420, a first UE may communicate with a first network node and a second network node in a full-duplexing mode (for example, a multi-TRP mode). For example, in example 420, the first UE may transmit one or more uplink transmissions to the first network node, and the first UE may concurrently receive one or more downlink transmissions from the second network node. Accordingly, in example 420, the first UE is operating in a full-duplexing mode, and the first and second network nodes are both operating in a half-duplexing mode. As shown in FIG. 4, the first UE may experience self-interference, where the uplink transmission to the first network node interferes with reception of the downlink transmission from the second network node. Furthermore, the uplink transmission by the first UE may cause inter-UE CLI at a second UE that is receiving a downlink transmission from the second network node. Furthermore, as shown, the downlink transmission by the second network node may cause inter-cell CLI interfering with reception of the uplink transmission from the first UE at the first network node. In example 420, the full-duplex communication may be performed in an SBFD mode, where a component carrier bandwidth is divided into non-overlapping uplink and downlink sub-bands, or in an IBFD mode, where uplink and downlink resources fully or partially overlap.

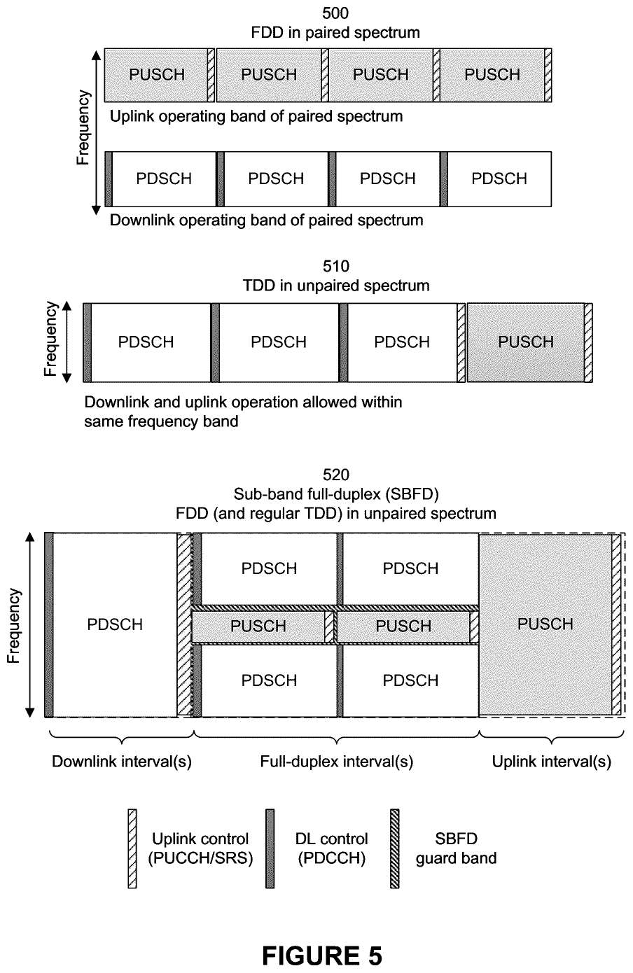

FIG. 5 is a diagram illustrating examples 500, 510, 520 of different duplexing modes in accordance with the present disclosure. For example, as described in further detail herein, FIG. 5 illustrates an example 500 of an FDD mode that may be used in paired spectrum, an example 510 of a TDD mode that may be used in unpaired spectrum, and an example 520 of an SBFD mode that may be used in unpaired spectrum. In general, a wireless communication standard and/or governing body may specify one or more duplexing modes in which a wireless spectrum is to be used. For example, 3GPP may specify how wireless spectrum is to be used for the 5G or NR RAT and interface. As an example, a specification may indicate whether a band is to be used as paired spectrum in an FDD mode, as unpaired spectrum in a TDD mode, or another mode.

For example, as shown by example 500, paired spectrum in the FDD mode may use a first frequency region (or channel) for uplink communication and a second frequency region (or channel) for downlink communication. In such cases, the frequency regions or channels used for uplink communication and downlink communication do not overlap, have different center frequencies, and have sufficient separation to prevent interference between the downlink communication and the uplink communication. For example, paired spectrum in FDD mode may include an uplink operating band and a downlink operating band that are configured to use non-overlapped frequency regions separated by a guard band. Accordingly, when operating in the FDD mode in paired spectrum, a UE with full-duplex capabilities may perform concurrent transmit and receive operations using the separate operating bands allocated to downlink and uplink communication. For example, paired bands in NR include NR operating bands n1, n2, n3, n5, n7, n8, n12, n20, n25, and n28, as specified by 3GPP TS 38.101-1.

Alternatively, as shown by example 510, unpaired spectrum in the TDD mode may allow downlink and uplink operation within a single frequency region (for example, a single operating band). For example, when operating in TDD mode in unpaired spectrum, downlink communication and uplink communication may occur in the same frequency range. Some deployments may use TDD in the unpaired band, whereby some transmission time intervals (for example, frames, slots, and/or symbols) are used for downlink communication only and other transmission time intervals are used for uplink communication only. In such examples, substantially the entire bandwidth of a component carrier may be used for downlink communication or uplink communication, depending on whether the communication is performed in a downlink interval, an uplink interval, or a special interval (in which either downlink or uplink communication can be scheduled). Examples of unpaired bands include NR operating bands n40, n41, and n50, as specified by 3GPP TS 38.101-1. In some cases, however, using TDD in unpaired spectrum may be inefficient. For example, uplink transmit power may be limited, meaning that UEs may be incapable of transmitting with enough power to efficiently utilize the full bandwidth of an uplink slot. This may be particularly problematic in large cells at the cell edge. Furthermore, using TDD may introduce latency relative to a full-duplex scheme in which uplink communications and downlink communications can be performed in the same time interval, since TDD restricts usage of a given transmission time interval to uplink or downlink communication only. Furthermore, using TDD may reduce spectral efficiency and/or reduce throughput by restricting usage of a given transmission time interval to uplink or downlink communication only.

Accordingly, as shown by example 520, an unpaired band may be configured in a full-duplexing mode to enable concurrent transmit and receive operations in unpaired spectrum (for example, a TDD band). For example, in FIG. 5, example 520 depicts an SBFD mode, which may be referred to herein as full-duplexing in a frequency division multiplexing (FDM) mode, in order to enable TDD operation and/or FDD operation in unpaired spectrum. For example, as shown in FIG. 5, an unpaired band configured in the SBFD mode may associate one or more transmission time intervals with downlink communication only (for example, “D” slots), one or more transmission time intervals for uplink communication only (for example, “U” slots), and one or more transmission time intervals for both downlink communication and uplink communication (for example, “D+U” slots). Each transmission time interval may be associated with a control region, illustrated as a portion of a time interval with a diagonal fill for uplink control (for example, a PUCCH) or a darker-shaded fill for downlink control (for example, a PDCCH). Additionally or alternatively, each time interval may be associated with a data region, which is shown as a PDSCH for downlink frequency regions or a PUSCH for uplink frequency regions.

In some aspects, an unpaired band configured in the SBFD mode may include one or more downlink-only time intervals, one or more uplink-only time intervals, and/or one or more full-duplex time intervals (for example, frames, subframes, slots, and/or symbols, among other examples) that are associated with an FDD configuration. For example, as shown in FIG. 5, the FDD configuration associated with a full-duplex time interval may indicate one or more downlink frequency regions (or sub-bands) and one or more uplink frequency regions (or sub-bands) that are separated by a guard band. Accordingly, an FDD configuration may divide an unpaired frequency band (for example, one or more component carriers of an unpaired band) into uplink frequency regions, downlink frequency regions, and/or other regions (for example, guard bands), which may enable a UE with full-duplex capabilities to perform simultaneous transmit and receive operations during one or more time intervals that are divided into downlink and uplink sub-bands with a guard band separation to prevent the uplink transmission from causing self-interference with respect to downlink reception. For example, in a given full-duplex time interval, a half-duplexing UE may either transmit using the uplink frequency region or receive in the downlink frequency region (for example, a first UE communicating using half-duplexing may only receive in a lower downlink frequency region during the full-duplex time intervals), and a full-duplexing UE may transmit using the uplink frequency region and/or receive in the downlink frequency region (for example, a second UE communicating using full-duplexing may receive in an upper downlink frequency region simultaneous with transmission in an uplink frequency region during the full-duplex time intervals). In some aspects, the FDD configuration may identify bandwidth part configurations corresponding to the uplink frequency regions and the downlink frequency regions. For example, a respective bandwidth part may be configured for each uplink frequency region and each downlink frequency region.

Additionally or alternatively, full-duplexing may be enabled in unpaired spectrum in an IBFD mode, which may be referred to herein as full-duplexing in a spatial division multiplexing (SDM) mode. For example, in an IBFD or SDM mode, uplink communication may occur on time and frequency resources that fully overlap in time and frequency resources allocated to downlink communication (for example, all of the time and frequency resources available for uplink communication are also available for downlink communication), or uplink communication may occur on time and frequency resources that partially overlap with time and frequency resources available for downlink communication (for example, some time and frequency resources available for uplink communication are also available for downlink communication and some time and frequency resources available for uplink communication are uplink-only). In general, in the IBFD mode, full-duplex communication may be conditional on sufficient beam separation between an uplink beam and a downlink beam (for example, uplink transmission may be from one antenna panel and downlink reception may be in another antenna panel) to minimize self-interference that may occur when a transmitted signal leaks into a receive port and/or when an object in a surrounding environment reflects a transmitted signal back to a receive port (for example, causing a clutter echo effect).

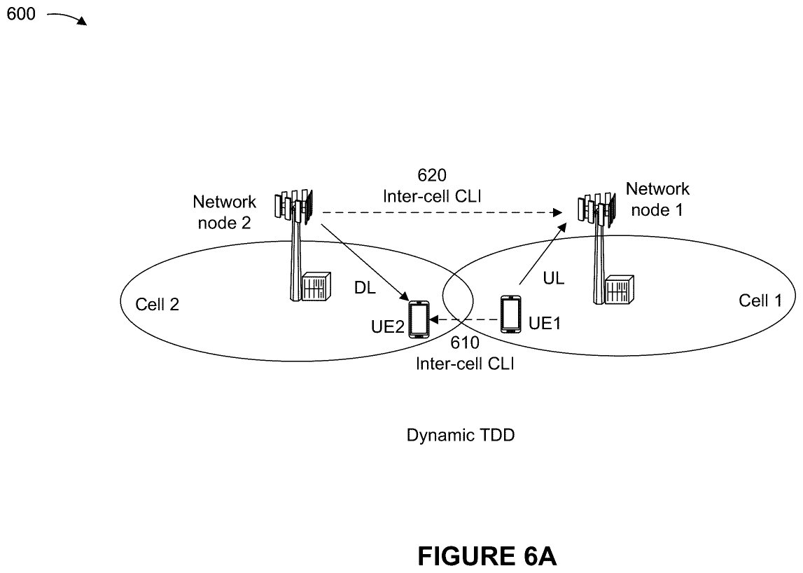

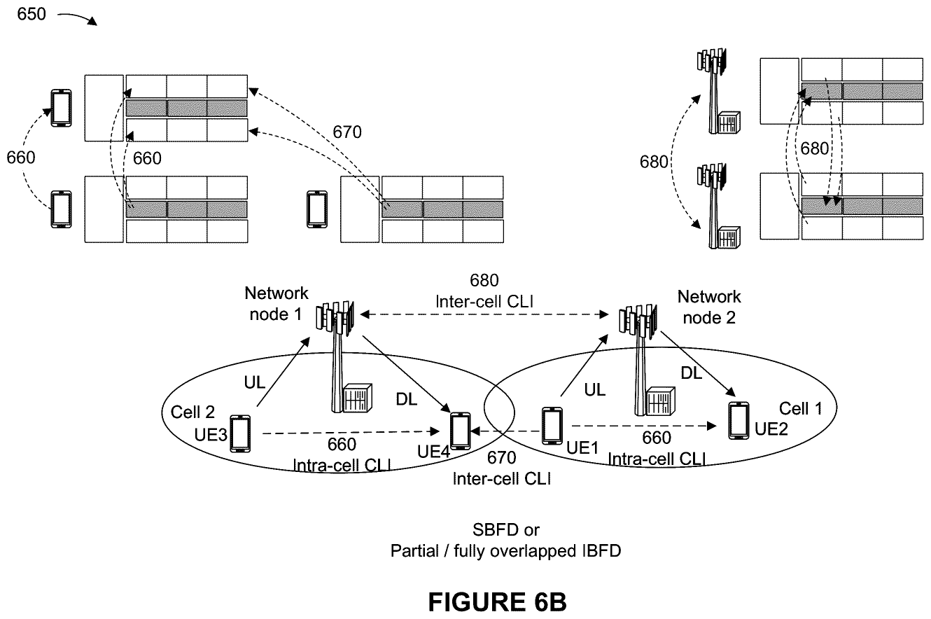

FIGS. 6A-6B are diagrams illustrating examples 600, 650 of inter-cell CLI and intra-cell CLI that may occur in dynamic TDD and/or full-duplex deployment scenarios in accordance with the present disclosure. For example, referring to FIG. 6A, example 600 depicts dynamic TDD communication. As shown in example 600, when dynamic TDD is implemented, neighboring cells (for example, cell 1 and cell 2 in FIG. 6A) may use different TDD configurations to communicate with served UEs in the respective cells, which may result in an uplink communication between a first UE (UE1) and a first network node (network node 1) in a same TTI as a downlink communication between a second network node (network node 2) and a second UE (UE2). The concurrent uplink and downlink communications in different transmission directions (for example, downlink versus uplink) in the same TTI may interfere with one another, which may be referred to as CLI. Interference with reception of a downlink communication by a first UE caused by transmission of an uplink communication by a second UE may be referred to as UE-to-UE CLI or inter-UE CLI. For example, as shown by reference number 610 in the dynamic TDD scenario shown in FIG. 6A, transmission of the uplink communication in a symbol or a slot by UE1 in cell 1 may interfere with reception of the downlink communication in the symbol or the slot by UE2 in cell 2. Such interference may be referred to as inter-cell UE-to-UE CLI or inter-cell inter-UE CLI. Additionally or alternatively, as shown by reference number 620, transmission of the downlink communication in a symbol or a slot by the second network node in cell 2 may interfere with reception of the uplink communication in the symbol or the slot by the second network node in cell 2. Such interference may be referred to as inter-cell network node-to-network node CLI, inter-cell inter-network node CLI, or inter-gNB CLI.

Referring to FIG. 6B, example 650 shows an example of full-duplex communication, such as SBFD, fully overlapping IBFD, or partially overlapping IBFD. As shown by reference number 660, in an FD scenario, transmission of an uplink communication in an SBFD or IBFD slot or symbol by a first UE in a cell may interfere with reception of a downlink communication in the SBFD or IBFD slot or symbol by a second UE in the cell. For example, transmission of an uplink communication in an SBFD or IBFD slot or symbol by a first UE (UE₁) in a first cell (cell 1) may interfere with reception of a downlink communication in the SBFD or IBFD slot or symbol by a second UE (UE₂) in cell 1. As another example, transmission of an uplink communication in an SBFD or IBFD slot or symbol by a third UE (UE3) in a second cell (cell 2) may interfere with reception of a downlink communication in the SBFD or IBFD slot or symbol by a fourth UE (UE4) in cell 2. Such interference may be referred to as intra-cell UE-to-UE CLI or intra-cell inter-UE CLI. In an SBFD scenario, transmission of an uplink communication on an uplink sub-band (SB) in an SBFD symbol or slot by one UE (for example, UE₁) in a cell (for example, cell 1) may interfere with reception of a downlink communication on a downlink SB in the SBFD symbol or slot by another UE (for example, UE₂) in the cell. Such interference may be referred to as inter-SB intra-cell UE-to-UE CLI or inter-SB intra-cell inter-UE CLI. Additionally or alternatively, as shown by reference number 670, in an FD scenario, transmission of an uplink communication in an SBFD or an IBFD symbol or slot by a first UE in a first cell may interfere with reception of a downlink communication in the SBFD or IBFD symbol or slot by a second UE in a second cell. Such interference may be referred to as inter-cell inter-UE CLI. In an SBFD scenario, transmission of an uplink communication on an uplink SB in an SBFD symbol or slot by a first UE in a first cell may interfere with reception of a downlink communication on a downlink SB in the SBFD symbol or slot by a second UE in a second cell. Such interference may be referred to as inter-SB inter-cell inter-UE CLI. Additionally or alternatively, as shown by reference number 680, transmission of a downlink communication in an SBFD or IBFD symbol or slot by a first network node in a first cell may interfere with reception of an uplink communication on an uplink SB in the SBFD or IBFD symbol or slot by a second network node in a second cell. Such interference may be referred to as inter-SB inter-cell inter-network node (or inter-gNB) CLI.

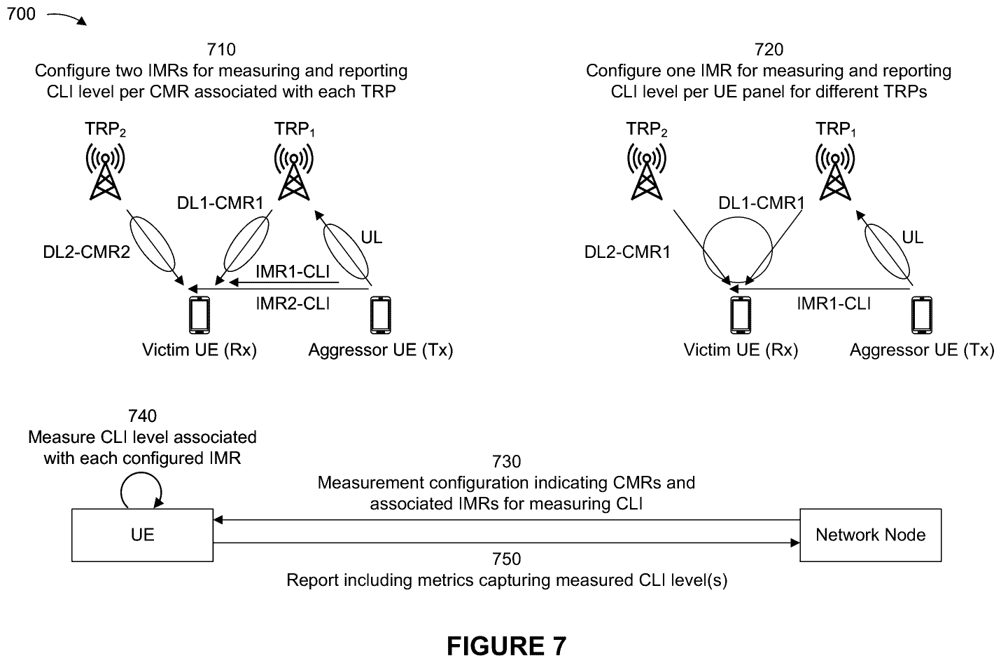

FIG. 7 is a diagram illustrating examples 700 associated with a CLI configuration under a CSI framework to support mTRP operation in accordance with the present disclosure. As shown in FIG. 7, examples 700 include communication between a UE, such as UE 120 or 220, and a network node, such as network node 110 or 210. In some aspects, the UE and the network node may be included in a wireless network, such as wireless network 100. The network node and the UE may communicate via a wireless access link, which may include an uplink and a downlink. Furthermore, as shown in FIG. 7, the network node and the UE may communicate in an mTRP scenario, where the network node includes, controls, or is otherwise associated with multiple TRPs. For example, FIG. 7 illustrates mTRP scenarios where the network node includes, controls, or is otherwise associated with a first TRP (shown as TRP₁) and a second TRP (shown as TRP₂) that can concurrently transmit downlink communications to the UE. In addition, one or more of the TRPs may be communicating in a dynamic TDD or full-duplexing mode, which may result in inter-UE CLI caused by an uplink transmission by a second (aggressor) UE concurrent with a downlink transmission to the first (victim) UE.

Accordingly, various aspects described herein relate generally to a CLI configuration that may be provided under a CSI framework to support mTRP operation in a manner that enables a victim UE to measure and report inter-UE CLI for each downlink receive beam that corresponds to a respective TRP that communicates with the UE in an SBFD mode, an IBFD mode, a dynamic TDD mode, and/or another suitable mode that may be subject to intra-cell inter-UE CLI and/or inter-cell inter-UE CLI. For example, as described herein, the CLI configuration to support mTRP operation may extend or may otherwise be defined in accordance with a CSI framework that enables mTRP operation, where a network node can configure a UE with multiple groups of resource sets that are respectively associated with multiple TRPs for downlink channel and interference measurements (for example, using a groupBasedBeamReporting-r17 parameter).

For example, when the network node configures the UE for mTRP operation in a scenario with two TRPs (such as the first TRP and the second TRP shown in FIG. 7), the network node may configure an NZP CSI-RS resource set that the UE may use for channel measurements. In such cases, the NZP CSI-RS resource set may include a quantity of resources, Kₛ, which may be divided into separate resource groups for each TRP. For example, a first resource group may include a first quantity of resources, K₁, for performing channel measurements with respect to a first TRP, and a second resource group may include a second quantity of resources, K₂, for performing channel measurements with respect to a second TRP. Furthermore, the first resource group and the second resource group may each include one or more resources (for example, such that K₁≥1 and K₂≥1) and the NZP CSI-RS resource set may include up to a maximum of 8 resources (for example, such that K₁+K₂=Kₛ and 2≤Kₛ≤8). Accordingly, when the UE is configured with the NZP CSI-RS resource set, the UE may be configured to transmit, to the network node, a report that indicates N resource pairs associated with best channel measurements, where each resource pair includes a first resource (for example, a first CMR) from the first resource group and a second resource (for example, a second CMR) from the second resource group, where N∈{1,2}. For example, the report provided by the UE may indicate the N resource pairs associated with best channel measurements in accordance with SINR measurements associated with the CMRs in the respective resource groups, which may enable the network node to select the best beam pairs associated with the two TRPs for mTRP operation.

Accordingly, in some aspects, the network node may adapt a measurement configuration associated with the CSI framework to provide the UE with a configuration to enable inter-UE CLI measurement and reporting. For example, FIG. 7 depicts a first scenario 710 in which a network node includes or controls a first TRP and a second TRP that are configured for mTRP operation and a first UE (shown as a victim UE) is configured to receive concurrent downlink transmissions from the first TRP using a first CMR corresponding to a first downlink beam (shown as DL-CMR1) and from the second TRP using a second CMR corresponding to a second downlink beam (shown as DL-CMR2). Furthermore, in the first scenario, the first TRP is configured to communicate in a full-duplexing mode, such as SBFD or IBFD, whereby a second UE (shown as an aggressor UE) may be configured to perform an uplink transmission to the first TRP concurrently with the downlink transmissions to the first (victim) UE. In the first scenario, the uplink transmission by the aggressor UE may cause inter-UE CLI with respect to reception of the downlink transmission from the first TRP and may also cause inter-UE CLI with respect to reception of the downlink transmission from the second TRP. However, because the victim UE is receiving concurrent downlink transmissions from the first TRP via a first downlink receive beam and from the second TRP via a second downlink receive beam, the inter-UE CLI caused by the aggressor UE may vary across the first CMR corresponding to the first downlink receive beam and the second CMR corresponding to the second downlink receive beam.

Accordingly, in the first scenario 710, where the victim UE uses different downlink receive beams to receive concurrent downlink transmissions from the first TRP and the second TRP, the network node may configure the victim UE to measure and report inter-UE CLI for each downlink receive beam that corresponds to each of the multiple TRPs in an SBFD, IBFD, dynamic TDD, or other duplexing scenario that may be subject to intra-cell inter-UE CLI and/or inter-cell inter-UE CLI. For example, in some aspects, the network node may configure a CLI measurement resource set per TRP (for example, two CLI measurement resource sets in the first scenario 710 where there are two TRPs), with each CLI measurement resource set configured as an IMR that the victim UE is to use to measure a CLI level for each CMR that is associated with a respective TRP. For example, in some aspects, the network node may configure a first CLI measurement resource set, which may include or correspond to a first IMR set, which includes one or more IMRs that the victim UE can use to measure an inter-UE CLI level with respect to each CMR that is configured for the first TRP. In a similar respect, the network node may configure a second CLI measurement resource set, which may include or correspond to a second IMR set, which includes one or more IMRs that the victim UE can use to measure an inter-UE CLI level with respect to each CMR that is configured for the second TRP. For example, as shown in FIG. 7, the first IMR set may include a first IMR (shown as IMR1-CLI) that the victim UE can measure to determine an inter-UE CLI level with respect to a CMR corresponding to a first downlink receive beam associated with the first TRP, and the second IMR set may include a second IMR (shown as IMR2-CLI) that the victim UE can measure to determine an inter-UE CLI level with respect to a CMR corresponding to a second downlink receive beam associated with the second TRP. In this way, the victim UE can use the different IMR sets to measure the inter-UE CLI level that the aggressor UE is causing with respect to downlink reception per TRP.

Additionally or alternatively, in a second scenario 720, the victim UE may communicate with different TRPs using a wider beam (for example, the different TRPs use downlink beams that share a spatial Rx parameter, or QCL Type-D relationship). In the second scenario 720, the victim UE may use the relatively wider downlink receive beam to concurrently receive downlink transmissions from the different TRPs. For example, as shown in FIG. 7, the victim UE may use the relatively wider downlink receive beam to concurrently receive a first downlink transmission from the first TRP and a second downlink transmission from the second TRP. In such cases, to improve reception performance, the victim UE may be configured to receive the first downlink transmission from the first TRP using a first panel (for example, a first antenna panel or a first set of antennas) and to receive the second downlink transmission from the second TRP using a second panel (for example, a second antenna panel or a second set of antennas). In such cases, the network node may configure one IMR that the victim UE can use to measure an inter-UE CLI level for the same downlink receive beam on one or more panels of the UE used to receive the downlink transmissions from the different TRPs. For example, as shown in FIG. 7, an IMR (shown as IMR1-CLI) can be configured to measure a first inter-UE CLI level with respect to a CMR associated with the downlink receive beam for the first TRP and to measure a second inter-UE CLI level with respect to the CMR associated with the downlink receive beam for the second TRP.

Accordingly, as further shown in FIG. 7, configuring the victim UE to measure and report inter-UE CLI may include a first operation 730 in which the network node transmits, and the (victim) UE receives, a measurement configuration that indicates one or more CMRs and associated IMRs for measuring a CLI level per CMR. For example, in some aspects, the measurement configuration provided by the network node may indicate a resource set per TRP, where each resource set may include one or more CMRs and one or more CLI IMRs. For example, in an mTRP configuration with two TRPs, the measurement configuration may indicate a first resource set that includes one or more CMRs associated with a first TRP, where the one or more CMRs in the first resource set are associated with one or more CLI IMRs that are associated with one or more aggressor UEs, one or more transmit beams of one or more aggressor UEs, and/or one or more receive beams of the victim UE. Furthermore, in an mTRP scenario with two TRPs, the measurement configuration may indicate a second resource set that includes one or more CMRs associated with a second TRP, where the one or more CMRs in the second resource set are associated with one or more CLI IMRs that are associated with one or more aggressor UEs, one or more transmit beams of one or more aggressor UEs, and/or one or more receive beams of the victim UE.

In some aspects, a mapping between the CMRs and the CLI IMRs in each resource set may be configurable depending on a use case associated with the mTRP operation that is enabled by the network node. For example, as described herein, each resource set may include a quantity of CMRs, K1, and a quantity of CLI IMRs, L, where L may be less than, equal to, or greater than K1. Furthermore, the mapping between the quantity of CMRs and the quantity of CLI IMRs may vary across resource sets associated with different TRPs. For example, a first resource set associated with a first TRP may include a quantity of CMRs that equals a quantity of CLI IMRs, and a second resource set associated with a second TRP may include a quantity of CMRs that is less than or greater than a quantity of CLI IMRs. For example, in a first mTRP use case, there may be one or more downlink receive beams that are free from inter-UE CLI or otherwise do not need CLI measurements, in which case the network node may configure a resource set in which the quantity of CLI IMRs is less than the quantity of CMRs (for example, L<K1). Additionally or alternatively, in a second mTRP use case, a resource set associated with a TRP may include multiple CMRs that are associated with different (relatively narrow) transmit beams at the TRP side, but the various transmit beams share a QCL Type-D relationship with respect to a wider downlink receive beam at the UE side. In this use case, the multiple CMRs associated with the TRP can share a CLI IMR for inter-UE CLI measurement, such that the quantity of CLI IMRs is less than the quantity of CMRs (for example, L<K1). Additionally or alternatively, in a third mTRP use case, a single CMR may be associated with inter-UE CLI measurements caused by multiple aggressor UEs or multiple transmit beams associated with an aggressor UE. In such a use case, the network node may configure multiple IMRs for the CMR to enable separate measurements of the CLI level per aggressor UE or per transmit beam of an aggressor UE, such that the quantity of CLI IMRs exceeds the quantity of CMRs (for example, L>K1).

Accordingly, in a second operation 740, the UE may measure an inter-UE CLI level associated with each CLI IMR configured by the network node (for example, with respect to each CMR in the same resource set). In a third operation 750, the UE may transmit a report that indicates or otherwise captures the inter-UE CLI level associated with each CLI IMR. For example, as described above, a UE that is configured to communicate with multiple TRPs may be configured to report the N best resource pairs, where each resource pair includes a first resource corresponding to a first CMR or downlink receive beam associated with a first TRP and a second resource corresponding to a second CMR or downlink receive beam associated with a second TRP. In some aspects, the inter-UE CLI level associated with each IMR may be implicitly captured using a CSI metric, such as a CQI value or an L1-SINR value. In such cases, the UE May consider the CLI level per IMR when calculating or otherwise determining the CQI value, L1-SINR value, or other CSI metric that is used to select the top N resource pairs to report to the network node for beam management and/or beam selection. For example, in some aspects, the CSI metric for a resource pair may be based on or otherwise associated with a joint CLI level that is measured for the multiple TRPs, or the CSI metric for a resource pair may be based on or otherwise associated with a CLI level that is measured separately per TRP (for example, in the case of non-coherent joint transmission, where each TRP can configure an independent precoder).

Additionally or alternatively, the report that is provided by the UE may independently indicate the inter-UE CLI level as a CLI metric. For example, in some aspects, the report may include a CLI-RSRP measurement, a CLI-RSSI measurement, a CLI-SINR measurement, or another suitable CLI metric to indicate the inter-UE CLI level for one or more IMRs and/or resource pairs. For example, in some aspects, the UE may report a quantity of CLI resources associated with the highest CLI per TRP, a quantity of CLI resources associated with the lowest CLI per TRP, a quantity of CLI resources associated with the highest CLI among the multiple TRPs, and/or a quantity of CLI resources associated with the lowest CLI among the multiple TRPs. In some aspects, the network node may configure the UE to report the inter-UE CLI level as a CLI metric in cases where interference varies faster than channel conditions, which may allow the network node to configure the UE to report CLI levels independently with a more frequent periodicity than CSI metrics (for example, CQI values) for mTRP operation.

Furthermore, in some aspects, the network node may configure the UE to report multiple hypotheses for the CLI level associated with mTRP operation using a single report configuration. For example, in some aspects, the network node may configure a QCL Type-D relationship with reference to a first SSB for a first resource group or resource set corresponding to a first TRP and with reference to a second SSB for a second resource group or resource set corresponding to a second TRP. In such cases, the UE can then report multiple CLI hypotheses in a single report. For example, in some aspects, the UE may report multiple hypotheses that include a first CLI metric measured with a QCL Type-D relationship for the first SSB for single TRP (sTRP) operation with the first TRP, where the first CLI metric corresponds to a first downlink receive beam, a second CLI metric measured with a QCL Type-D relationship for the second SSB for sTRP operation with the second TRP, where the second CLI metric corresponds to a second downlink receive beam, and a third CLI metric measured with a QCL Type-D relationship for the first SSB and the second SSB for mTRP operation with the first and second TRP. Furthermore, the third CLI metric for mTRP operation may correspond to a pair of downlink receive beams that may be the same as or different from the beams that are selected for sTRP operation (for example, because interference conditions may vary, and the UE can identify the corresponding downlink receive beams in a periodic beam management and/or beam selection procedure). In this way, the network node may determine whether the UE is able to use different downlink receive beams to support sTRP operation and/or mTRP operation within tolerable CLI limits.

FIG. 8 is a flowchart illustrating an example process 800 performed, for example, at a UE or an apparatus of a UE that supports CLI measurement and reporting for mTRP operation in accordance with the present disclosure. Example process 800 is an example where the apparatus or the UE (for example, UE 120 or UE 220) performs operations associated with a CLI configuration under a CSI framework to support mTRP.

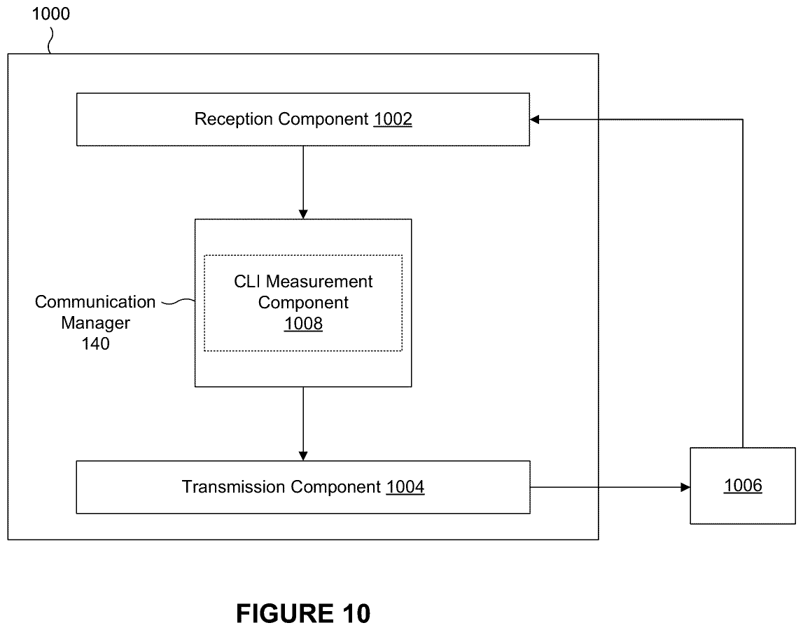

As shown in FIG. 8, in some aspects, process 800 may include receiving, from a network node, a configuration that indicates a first measurement resource set and a second measurement resource set, wherein the first measurement resource set and the second measurement resource set each include one or more IMRs (block 810). For example, the UE (such as by using communication manager 140 or reception component 1002, depicted in FIG. 10) may receive, from a network node, a configuration that indicates a first measurement resource set and a second measurement resource set, wherein the first measurement resource set and the second measurement resource set each include one or more IMRs, as described above.

As further shown in FIG. 8, in some aspects, process 800 may include measuring, for each IMR included in the first measurement resource set or the second measurement resource set, a CLI level associated with a downlink receive beam associated with one or more of a first TRP or a second TRP (block 820). For example, the UE (such as by using communication manager 140 or CLI measurement component 1008, depicted in FIG. 10) may measure, for each IMR included in the first measurement resource set or the second measurement resource set, a CLI level associated with a downlink receive beam associated with one or more of a first TRP or a second TRP, as described above.

As further shown in FIG. 8, in some aspects, process 800 may include transmitting, to the network node, a report that includes information related to the CLI level associated with each of the one or more IMRs included in the first measurement resource set and the second measurement resource set (block 830). For example, the UE (such as by using communication manager 140 or transmission component 1004, depicted in FIG. 10) may transmit, to the network node, a report that includes information related to the CLI level associated with each of the one or more IMRs included in the first measurement resource set and the second measurement resource set, as described above.

Process 800 may include additional aspects, such as any single aspect or any combination of aspects described below or in connection with one or more other processes described elsewhere herein.

In a first additional aspect, the first measurement resource set and the second measurement resource set each include a first IMR set to measure the CLI level associated with one or more downlink receive beams associated with the first TRP and a second IMR set to measure the CLI level associated with one or more downlink receive beams associated with the second TRP.

In a second additional aspect, alone or in combination with the first aspect, the first measurement resource set and the second measurement resource set each include at least one IMR set to measure the CLI level associated with a same downlink receive beam associated with the first TRP and the second TRP.

In a third additional aspect, alone or in combination with one or more of the first and second aspects, the CLI level associated with the at least one IMR set includes a first CLI level associated with the downlink receive beam on a first panel and a second CLI level associated with the downlink receive beam on a second panel.

In a fourth additional aspect, alone or in combination with one or more of the first through third aspects, the first measurement resource set includes a first set of CMRs associated with a first set of IMRs, and the second measurement resource set includes a second set of CMRs associated with a second set of IMRs.

In a fifth additional aspect, alone or in combination with one or more of the first through fourth aspects, the first set of IMRs are associated with measuring the CLI level with respect to the first set of CMRs for the first TRP, and the second set of IMRs are associated with measuring the CLI level with respect to the second set of CMRs for the second TRP.

In a sixth additional aspect, alone or in combination with one or more of the first through fifth aspects, the first set of IMRs and the second set of IMRs are each associated with one or more aggressor UEs, one or more transmit beams associated with the one or more aggressor UEs, or one or more receive beams of the UE.

In a seventh additional aspect, alone or in combination with one or more of the first through sixth aspects, one or more of the first measurement resource set or the second measurement resource set includes equal quantities of CMRs and IMRs.

In an eighth additional aspect, alone or in combination with one or more of the first through seventh aspects, one or more of the first measurement resource set or the second measurement resource set includes a quantity of CMRs that exceeds a quantity of IMRs.

In a ninth additional aspect, alone or in combination with one or more of the first through eighth aspects, one or more of the first measurement resource set or the second measurement resource set includes a quantity of IMRs that exceeds a quantity of CMRs.

In a tenth additional aspect, alone or in combination with one or more of the first through ninth aspects, the report indicates the CLI level associated with each IMR according to one or more CSI metrics.

In an eleventh additional aspect, alone or in combination with one or more of the first through tenth aspects, the report indicates the CLI level associated with each IMR according to a CLI metric.

In a twelfth additional aspect, alone or in combination with one or more of the first through eleventh aspects, the report indicates, per each of the first TRP and the second TRP, one or more IMRs associated with highest values for the CLI metric or one or more IMRs associated with lowest values for the CLI metric.

In a thirteenth additional aspect, alone or in combination with one or more of the first through twelfth aspects, the report indicates, among the first TRP and the second TRP, one or more IMRs associated with highest values for the CLI metric or one or more IMRs associated with lowest values for the CLI metric.

In a fourteenth additional aspect, alone or in combination with one or more of the first through thirteenth aspects, the configuration indicates multiple hypotheses for the CLI level to be indicated in the report.

In a fifteenth additional aspect, alone or in combination with one or more of the first through fourteenth aspects, the multiple hypotheses include a CLI metric measured with respect to a downlink receive beam associated with communicating with the first TRP in single TRP operation.

In a sixteenth additional aspect, alone or in combination with one or more of the first through fifteenth aspects, the multiple hypotheses include a CLI metric measured with respect to a downlink receive beam associated with communicating with the second TRP in single TRP operation.

In a seventeenth additional aspect, alone or in combination with one or more of the first through sixteenth aspects, the multiple hypotheses include a CLI metric measured with respect to one or more downlink receive beams associated with communicating with the first TRP and the second TRP in multiple TRP operation.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a flowchart illustrating an example process 900 performed, for example, at a network node or an apparatus of a network node that supports configuring CLI measurement and reporting in accordance with the present disclosure. Example process 900 is an example where the apparatus or the network node (for example, network node 110) performs operations associated with a CLI configuration under a CSI framework to support mTRP.

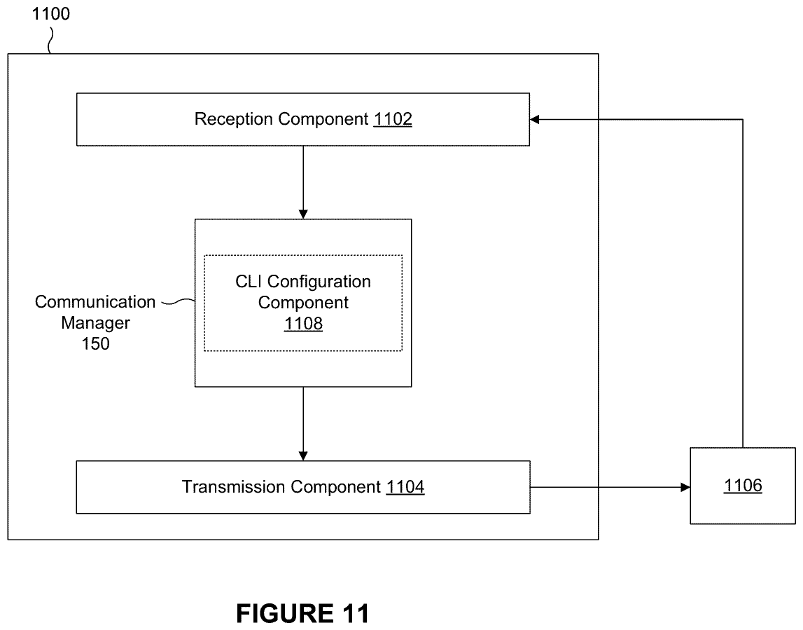

As shown in FIG. 9, in some aspects, process 900 may include transmitting, to a UE, a configuration that indicates a first measurement resource set and a second measurement resource set, wherein the first measurement resource set and the second measurement resource set each include one or more IMRs (block 910). For example, the network node (such as by using communication manager 150 or transmission component 1104, depicted in FIG. 11) may transmit, to a UE, a configuration that indicates a first measurement resource set and a second measurement resource set, wherein the first measurement resource set and the second measurement resource set each include one or more IMRs, as described above.

As further shown in FIG. 9, in some aspects, process 900 may include receiving, from the UE, a report that includes information related to a CLI level associated with each of the one or more IMRs included in the first measurement resource set and the second measurement resource set for a first TRP or a second TRP (block 920). For example, the network node (such as by using communication manager 150 or reception component 1102, depicted in FIG. 11) may receive, from the UE, a report that includes information related to a CLI level associated with each of the one or more IMRs included in the first measurement resource set and the second measurement resource set for a first TRP or a second TRP, as described above.

Process 900 may include additional aspects, such as any single aspect or any combination of aspects described below or in connection with one or more other processes described elsewhere herein.

In a first additional aspect, the first measurement resource set and the second measurement resource set each include a first IMR set to measure the CLI level associated with one or more downlink receive beams associated with the first TRP and a second IMR set to measure the CLI level associated with one or more downlink receive beams associated with the second TRP.

In a second additional aspect, alone or in combination with the first aspect, the first measurement resource set and the second measurement resource set each include at least one IMR set to measure the CLI level associated with a same downlink receive beam associated with the first TRP and the second TRP.

In a third additional aspect, alone or in combination with one or more of the first and second aspects, the CLI level associated with the at least one IMR set includes a first CLI level associated with the downlink receive beam on a first panel and a second CLI level associated with the downlink receive beam on a second panel.

In a fourth additional aspect, alone or in combination with one or more of the first through third aspects, the first measurement resource set includes a first set of CMRs associated with a first set of IMRs, and the second measurement resource set includes a second set of CMRs associated with a second set of IMRs.

In a fifth additional aspect, alone or in combination with one or more of the first through fourth aspects, the first set of IMRs are associated with measuring the CLI level with respect to the first set of CMRs for the first TRP, and the second set of IMRs are associated with measuring the CLI level with respect to the second set of CMRs for the second TRP.

In a sixth additional aspect, alone or in combination with one or more of the first through fifth aspects, the first set of IMRs and the second set of IMRs are each associated with one or more aggressor UEs, one or more transmit beams associated with the one or more aggressor UEs, or one or more receive beams of the UE.

In a seventh additional aspect, alone or in combination with one or more of the first through sixth aspects, one or more of the first measurement resource set or the second measurement resource set includes equal quantities of CMRs and IMRs.

In an eighth additional aspect, alone or in combination with one or more of the first through seventh aspects, one or more of the first measurement resource set or the second measurement resource set includes a quantity of CMRs that exceeds a quantity of IMRs.

In a ninth additional aspect, alone or in combination with one or more of the first through eighth aspects, one or more of the first measurement resource set or the second measurement resource set includes a quantity of IMRs that exceeds a quantity of CMRs.

In a tenth additional aspect, alone or in combination with one or more of the first through ninth aspects, the report indicates the CLI level associated with each IMR according to one or more CSI metrics.

In an eleventh additional aspect, alone or in combination with one or more of the first through tenth aspects, the report indicates the CLI level associated with each IMR according to a CLI metric.

In a twelfth additional aspect, alone or in combination with one or more of the first through eleventh aspects, the report indicates, per each of the first TRP and the second TRP, one or more IMRs associated with highest values for the CLI metric or one or more IMRs associated with lowest values for the CLI metric.

In a thirteenth additional aspect, alone or in combination with one or more of the first through twelfth aspects, the report indicates, among the first TRP and the second TRP, one or more IMRs associated with highest values for the CLI metric or one or more IMRs associated with lowest values for the CLI metric.

In a fourteenth additional aspect, alone or in combination with one or more of the first through thirteenth aspects, the configuration indicates multiple hypotheses for the CLI level to be indicated in the report.

In a fifteenth additional aspect, alone or in combination with one or more of the first through fourteenth aspects, the multiple hypotheses include a CLI metric measured with respect to a downlink receive beam associated with communicating with the first TRP in single TRP operation.

In a sixteenth additional aspect, alone or in combination with one or more of the first through fifteenth aspects, the multiple hypotheses include a CLI metric measured with respect to a downlink receive beam associated with communicating with the second TRP in single TRP operation.

In a seventeenth additional aspect, alone or in combination with one or more of the first through sixteenth aspects, the multiple hypotheses include a CLI metric measured with respect to one or more downlink receive beams associated with communicating with the first TRP and the second TRP in multiple TRP operation.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a diagram of an example apparatus 1000 for wireless communication that supports measuring and reporting CLI in accordance with the present disclosure. The apparatus 1000 may be a UE, or a UE may include the apparatus 1000. In some aspects, the apparatus 1000 includes a reception component 1002, a transmission component 1004, and a communication manager 140, which may be in communication with one another (for example, via one or more buses). As shown, the apparatus 1000 may communicate with another apparatus 1006 (such as a UE, a network node, or another wireless communication device) using the reception component 1002 and the transmission component 1004.

In some aspects, the apparatus 1000 may be configured to and/or operable to perform one or more operations described herein in connection with FIG. 7. Additionally or alternatively, the apparatus 1000 may be configured to and/or operable to perform one or more processes described herein, such as process 800 of FIG. 8. In some aspects, the apparatus 1000 may include one or more components of the UE described above in connection with FIG. 2.

The reception component 1002 may receive communications, such as reference signals, control information, and/or data communications, from the apparatus 1006. The reception component 1002 may provide received communications to one or more other components of the apparatus 1000, such as the communication manager 140. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, one or more modems, one or more demodulators, one or more MIMO detectors, one or more receive processors, one or more controllers/processors, and/or one or more memories of the UE described above in connection with FIG. 2.

The transmission component 1004 may transmit communications, such as reference signals, control information, and/or data communications, to the apparatus 1006. In some aspects, the communication manager 140 may generate communications and may transmit the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 1004 may be co-located with the reception component 1002 in one or more transceivers.

The communication manager 140 may receive or may cause the reception component 1002 to receive, from a network node, a configuration that indicates a first measurement resource set and a second measurement resource set, wherein the first measurement resource set and the second measurement resource set each include one or more IMRs. The communication manager 140 may measure, for each IMR included in the first measurement resource set or the second measurement resource set, a CLI level associated with a downlink receive beam associated with one or more of a first TRP or a second TRP. The communication manager 140 may transmit or may cause the transmission component 1004 to transmit, to the network node, a report that includes information related to the CLI level associated with each of the one or more IMRs included in the first measurement resource set and the second measurement resource set. In some aspects, the communication manager 140 may perform one or more operations described elsewhere herein as being performed by one or more components of the communication manager 140.

The communication manager 140 may include one or more controllers/processors and/or one or more memories of the UE described above in connection with FIG. 2. In some aspects, the communication manager 140 includes a set of components, such as a CLI configuration component 1008. Alternatively, the set of components may be separate and distinct from the communication manager 140. In some aspects, one or more components of the set of components may include or may be implemented within one or more controllers/processors and/or one or more memories of the UE described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive, from a network node, a configuration that indicates a first measurement resource set and a second measurement resource set, wherein the first measurement resource set and the second measurement resource set each include one or more IMRs. The CLI measurement component 1008 may measure, for each IMR included in the first measurement resource set or the second measurement resource set, a CLI level associated with a downlink receive beam associated with one or more of a first TRP or a second TRP. The transmission component 1004 may transmit, to the network node, a report that includes information related to the CLI level associated with each of the one or more IMRs included in the first measurement resource set and the second measurement resource set.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

FIG. 11 is a diagram of an example apparatus 1100 for wireless communication that supports configuring CLI measurement and reporting in accordance with the present disclosure. The apparatus 1100 may be a network node, or a network node may include the apparatus 1100. In some aspects, the apparatus 1100 includes a reception component 1102, a transmission component 1104, and a communication manager 150, which may be in communication with one another (for example, via one or more buses). As shown, the apparatus 1100 may communicate with another apparatus 1106 (such as a UE, a network node, or another wireless communication device) using the reception component 1102 and the transmission component 1104.

In some aspects, the apparatus 1100 may be configured to and/or operable to perform one or more operations described herein in connection with FIG. 7. Additionally or alternatively, the apparatus 1100 may be configured to and/or operable to perform one or more processes described herein, such as process 900 of FIG. 9. In some aspects, the apparatus 1100 may include one or more components of the network node described above in connection with FIG. 2.

The reception component 1102 may receive communications, such as reference signals, control information, and/or data communications, from the apparatus 1106. The reception component 1102 may provide received communications to one or more other components of the apparatus 1100, such as the communication manager 150. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1102 may include one or more antennas, one or more modems, one or more demodulators, one or more MIMO detectors, one or more receive processors, one or more controllers/processors, and/or one or more memories of the network node described above in connection with FIG. 2.

The transmission component 1104 may transmit communications, such as reference signals, control information, and/or data communications, to the apparatus 1106. In some aspects, the communication manager 150 may generate communications and may transmit the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 1104 may be co-located with the reception component 1102 in one or more transceivers.

The communication manager 150 may transmit or may cause the transmission component 1104 to transmit, to a UE, a configuration that indicates a first measurement resource set and a second measurement resource set, wherein the first measurement resource set and the second measurement resource set each include one or more IMRs. The communication manager 150 may receive or may cause the reception component 1102 to receive, from the UE, a report that includes information related to a CLI level associated with each of the one or more IMRs included in the first measurement resource set and the second measurement resource set for a first TRP or a second TRP. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 2. In some aspects, the communication manager 150 includes a set of components, such as a CLI configuration component 1108. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The CLI configuration component 1108 may determine a first measurement resource set and a second measurement resource set, wherein the first measurement resource set and the second measurement resource set each include one or more IMRs. The transmission component 1104 may transmit, to a UE, a configuration that indicates the first measurement resource set and the second measurement resource set, wherein the first measurement resource set and the second measurement resource set each include one or more IMRs. The reception component 1102 may receive, from the UE, a report that includes information related to a CLI level associated with each of the one or more IMRs included in the first measurement resource set and the second measurement resource set for a first TRP or a second TRP.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

The following provides an overview of some Aspects of the present disclosure:
Aspect 1: A method for wireless communication by a UE, comprising: receiving, from a network node, a configuration that indicates a first measurement resource set and a second measurement resource set, wherein the first measurement resource set and the second measurement resource set each include one or more IMRs; measuring, for each IMR included in the first measurement resource set or the second measurement resource set, a CLI level associated with a downlink receive beam associated with one or more of a first TRP or a second TRP; and transmitting, to the network node, a report that includes information related to the CLI level associated with each of the one or more IMRs included in the first measurement resource set and the second measurement resource set.
Aspect 2: The method of Aspect 1, wherein the first measurement resource set and the second measurement resource set each include a first IMR set to measure the CLI level associated with one or more downlink receive beams associated with the first TRP and a second IMR set to measure the CLI level associated with one or more downlink receive beams associated with the second TRP.
Aspect 3: The method of any of Aspects 1-2, wherein the first measurement resource set and the second measurement resource set each include at least one IMR set to measure the CLI level associated with a same downlink receive beam associated with the first TRP and the second TRP.
Aspect 4: The method of Aspect 3, wherein the CLI level associated with the at least one IMR set includes a first CLI level associated with the downlink receive beam on a first panel and a second CLI level associated with the downlink receive beam on a second panel.
Aspect 5: The method of any of Aspects 1-4, wherein the first measurement resource set includes a first set of CMRs associated with a first set of IMRs, and wherein the second measurement resource set includes a second set of CMRs associated with a second set of IMRs.
Aspect 6: The method of Aspect 5, wherein the first set of IMRs are associated with measuring the CLI level with respect to the first set of CMRs for the first TRP, and wherein the second set of IMRs are associated with measuring the CLI level with respect to the second set of CMRs for the second TRP.
Aspect 7: The method of Aspect 5, wherein the first set of IMRs and the second set of IMRs are each associated with one or more aggressor UEs, one or more transmit beams associated with the one or more aggressor UEs, or one or more receive beams of the UE.
Aspect 8: The method of Aspect 5, wherein one or more of the first measurement resource set or the second measurement resource set includes equal quantities of CMRs and IMRs.
Aspect 9: The method of Aspect 5, wherein one or more of the first measurement resource set or the second measurement resource set includes a quantity of CMRs that exceeds a quantity of IMRs.
Aspect 10: The method of Aspect 5, wherein one or more of the first measurement resource set or the second measurement resource set includes a quantity of IMRs that exceeds a quantity of CMRs.
Aspect 11: The method of any of Aspects 1-10, wherein the report indicates the CLI level associated with each IMR according to one or more CSI metrics.
Aspect 12: The method of any of Aspects 1-11, wherein the report indicates the CLI level associated with each IMR according to a CLI metric.
Aspect 13: The method of Aspect 12, wherein the report indicates, per each of the first TRP and the second TRP, one or more IMRs associated with highest values for the CLI metric or one or more IMRs associated with lowest values for the CLI metric.
Aspect 14: The method of Aspect 12, wherein the report indicates, among the first TRP and the second TRP, one or more IMRs associated with highest values for the CLI metric or one or more IMRs associated with lowest values for the CLI metric.
Aspect 15: The method of any of Aspects 1-14, wherein the configuration indicates multiple hypotheses for the CLI level to be indicated in the report.
Aspect 16: The method of Aspect 15, wherein the multiple hypotheses include a CLI metric measured with respect to a downlink receive beam associated with communicating with the first TRP in single TRP operation.
Aspect 17: The method of Aspect 15, wherein the multiple hypotheses include a CLI metric measured with respect to a downlink receive beam associated with communicating with the second TRP in single TRP operation.
Aspect 18: The method of Aspect 15, wherein the multiple hypotheses include a CLI metric measured with respect to one or more downlink receive beams associated with communicating with the first TRP and the second TRP in multiple TRP operation.
Aspect 19: A method of wireless communication performed by a network node, comprising: transmitting, to a UE, a configuration that indicates a first measurement resource set and a second measurement resource set, wherein the first measurement resource set and the second measurement resource set each include one or more IMRs; and receiving, from the UE, a report that includes information related to a CLI level associated with each of the one or more IMRs included in the first measurement resource set and the second measurement resource set for a first TRP or a second TRP.
Aspect 20: The method of Aspect 19, wherein the first measurement resource set and the second measurement resource set each include a first IMR set to measure the CLI level associated with one or more downlink receive beams associated with the first TRP and a second IMR set to measure the CLI level associated with one or more downlink receive beams associated with the second TRP.
Aspect 21: The method of any of Aspects 19-20, wherein the first measurement resource set and the second measurement resource set each include at least one IMR set to measure the CLI level associated with a same downlink receive beam associated with the first TRP and the second TRP.
Aspect 22: The method of Aspect 21, wherein the CLI level associated with the at least one IMR set includes a first CLI level associated with the downlink receive beam on a first panel and a second CLI level associated with the downlink receive beam on a second panel.
Aspect 23: The method of any of Aspects 19-22, wherein the first measurement resource set includes a first set of CMRs associated with a first set of IMRs, and wherein the second measurement resource set includes a second set of CMRs associated with a second set of IMRs.
Aspect 24: The method of Aspect 23, wherein the first set of IMRs are associated with measuring the CLI level with respect to the first set of CMRs for the first TRP, and wherein the second set of IMRs are associated with measuring the CLI level with respect to the second set of CMRs for the second TRP.
Aspect 25: The method of Aspect 23, wherein the first set of IMRs and the second set of IMRs are each associated with one or more aggressor UEs, one or more transmit beams associated with the one or more aggressor UEs, or one or more receive beams of the UE.
Aspect 26: The method of Aspect 23, wherein one or more of the first measurement resource set or the second measurement resource set includes equal quantities of CMRs and IMRs.
Aspect 27: The method of Aspect 23, wherein one or more of the first measurement resource set or the second measurement resource set includes a quantity of CMRs that exceeds a quantity of IMRs.
Aspect 28: The method of Aspect 23, wherein one or more of the first measurement resource set or the second measurement resource set includes a quantity of IMRs that exceeds a quantity of CMRs.
Aspect 29: The method of any of Aspects 19-28, wherein the report indicates the CLI level associated with each IMR according to one or more CSI metrics.
Aspect 30: The method of any of Aspects 19-29, wherein the report indicates the CLI level associated with each IMR according to a CLI metric.
Aspect 31: The method of Aspect 30, wherein the report indicates, per each of the first TRP and the second TRP, one or more IMRs associated with highest values for the CLI metric or one or more IMRs associated with lowest values for the CLI metric.
Aspect 32: The method of Aspect 30, wherein the report indicates, among the first TRP and the second TRP, one or more IMRs associated with highest values for the CLI metric or one or more IMRs associated with lowest values for the CLI metric.
Aspect 33: The method of any of Aspects 19-32, wherein the configuration indicates multiple hypotheses for the CLI level to be indicated in the report.
Aspect 34: The method of Aspect 33, wherein the multiple hypotheses include a CLI metric measured with respect to a downlink receive beam associated with communicating with the first TRP in single TRP operation.
Aspect 35: The method of Aspect 33, wherein the multiple hypotheses include a CLI metric measured with respect to a downlink receive beam associated with communicating with the second TRP in single TRP operation.
Aspect 36: The method of Aspect 33, wherein the multiple hypotheses include a CLI metric measured with respect to one or more downlink receive beams associated with communicating with the first TRP and the second TRP in multiple TRP operation.
Aspect 37: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-36.
Aspect 38: An apparatus for wireless communication at a device, the apparatus comprising one or more memories and one or more processors coupled to the one or more memories, the one or more processors configured to cause the device to perform the method of one or more of Aspects 1-36.
Aspect 39: An apparatus for wireless communication, the apparatus comprising at least one means for performing the method of one or more of Aspects 1-36.
Aspect 40: A non-transitory computer-readable medium storing code for wireless communication, the code comprising instructions executable by one or more processors to perform the method of one or more of Aspects 1-36.
Aspect 41: A non-transitory computer-readable medium storing a set of instructions for wireless communication, the set of instructions comprising one or more instructions that, when executed by one or more processors of a device, cause the device to perform the method of one or more of Aspects 1-36.
Aspect 42: A device for wireless communication, the device comprising a processing system that includes one or more processors and one or more memories coupled with the one or more processors, the processing system configured to cause the device to perform the method of one or more of Aspects 1-36.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a +a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
receive, from a network node, a configuration that indicates a first measurement resource set and a second measurement resource set, wherein the first measurement resource set and the second measurement resource set each include one or more interference measurement resources (IMRs);
measure, for each IMR included in the first measurement resource set or the second measurement resource set, a cross-link interference (CLI) level associated with a downlink receive beam associated with one or more of a first transmission reception point (TRP) or a second TRP; and
transmit, to the network node, a report that includes information related to the CLI level associated with each of the one or more IMRs included in the first measurement resource set and the second measurement resource set.

2. The UE of claim 1, wherein the first measurement resource set and the second measurement resource set each include a first IMR set to measure the CLI level associated with one or more downlink receive beams associated with the first TRP and a second IMR set to measure the CLI level associated with one or more downlink receive beams associated with the second TRP.

3. The UE of claim 1, wherein the first measurement resource set and the second measurement resource set each include at least one IMR set to measure the CLI level associated with a same downlink receive beam associated with the first TRP and the second TRP.

4. The UE of claim 3, wherein the CLI level associated with the at least one IMR set includes a first CLI level associated with the downlink receive beam on a first panel and a second CLI level associated with the downlink receive beam on a second panel.

5. The UE of claim 1, wherein the first measurement resource set includes a first set of channel measurement resources (CMRs) associated with a first set of IMRs, and wherein the second measurement resource set includes a second set of CMRs associated with a second set of IMRs.

6. The UE of claim 5, wherein the first set of IMRs are associated with measuring the CLI level with respect to the first set of CMRs for the first TRP, and wherein the second set of IMRs are associated with measuring the CLI level with respect to the second set of CMRs for the second TRP.

7. The UE of claim 5, wherein the first set of IMRs and the second set of IMRs are each associated with one or more aggressor UEs, one or more transmit beams associated with the one or more aggressor UEs, or one or more receive beams of the UE.

8. The UE of claim 5, wherein one or more of the first measurement resource set or the second measurement resource set includes equal quantities of CMRs and IMRs.

9. The UE of claim 5, wherein one or more of the first measurement resource set or the second measurement resource set includes a quantity of CMRs that exceeds a quantity of IMRs.

10. The UE of claim 5, wherein one or more of the first measurement resource set or the second measurement resource set includes a quantity of IMRs that exceeds a quantity of CMRs.

11. The UE of claim 1, wherein the report indicates the CLI level associated with each IMR according to one or more channel state information (CSI) metrics.

12. The UE of claim 1, wherein the report indicates the CLI level associated with each IMR according to a CLI metric.

13. The UE of claim 12, wherein the report indicates, per each of the first TRP and the second TRP, one or more IMRs associated with highest values for the CLI metric or one or more IMRs associated with lowest values for the CLI metric.

14. The UE of claim 12, wherein the report indicates, among the first TRP and the second TRP, one or more IMRs associated with highest values for the CLI metric or one or more IMRs associated with lowest values for the CLI metric.

15. The UE of claim 1, wherein the configuration indicates multiple hypotheses for the CLI level to be indicated in the report.

16. The UE of claim 15, wherein the multiple hypotheses include a CLI metric measured with respect to a downlink receive beam associated with communicating with the first TRP in single TRP operation.

17. The UE of claim 15, wherein the multiple hypotheses include a CLI metric measured with respect to a downlink receive beam associated with communicating with the second TRP in single TRP operation.

18. The UE of claim 15, wherein the multiple hypotheses include a CLI metric measured with respect to one or more downlink receive beams associated with communicating with the first TRP and the second TRP in multiple TRP operation.

19. A network node for wireless communication, comprising:
a processing system that includes one or more processors and one or more memories coupled with the one or more processors, the processing system configured to cause the network node to:
transmit, to a user equipment (UE), a configuration that indicates a first measurement resource set and a second measurement resource set, wherein the first measurement resource set and the second measurement resource set each include one or more interference measurement resources (IMRs); and
receive, from the UE, a report that includes information related to a cross-link interference (CLI) level associated with each of the one or more IMRs included in the first measurement resource set and the second measurement resource set for a first transmission reception point (TRP) or a second TRP.

20. The network node of claim 19, wherein the first measurement resource set and the second measurement resource set each include a first IMR set to measure the CLI level associated with one or more downlink receive beams associated with the first TRP and a second IMR set to measure the CLI level associated with one or more downlink receive beams associated with the second TRP.

21. The network node of claim 19, wherein the first measurement resource set and the second measurement resource set each include at least one IMR set to measure the CLI level associated with a same downlink receive beam associated with the first TRP and the second TRP.

22. The network node of claim 21, wherein the CLI level associated with the at least one IMR set includes a first CLI level associated with the downlink receive beam on a first panel and a second CLI level associated with the downlink receive beam on a second panel.

23. The network node of claim 19, wherein the first measurement resource set includes a first set of channel measurement resources (CMRs) associated with a first set of IMRs, and wherein the second measurement resource set includes a second set of CMRs associated with a second set of IMRs.

24. The network node of claim 23, wherein the first set of IMRs are associated with measuring the CLI level with respect to the first set of CMRs for the first TRP, and wherein the second set of IMRs are associated with measuring the CLI level with respect to the second set of CMRs for the second TRP.

25. The network node of claim 23, wherein the first set of IMRs and the second set of IMRs are each associated with one or more aggressor UEs, one or more transmit beams associated with the one or more aggressor UEs, or one or more receive beams of the UE.

26. The network node of claim 19, wherein the report indicates the CLI level associated with each IMR according to one or more channel state information (CSI) metrics.

27. The network node of claim 19, wherein the report indicates the CLI level associated with each IMR according to a CLI metric.

28. The network node of claim 19, wherein the configuration indicates multiple hypotheses for the CLI level to be indicated in the report.

29. A method for wireless communication by a user equipment (UE), comprising:
receiving, from a network node, a configuration that indicates a first measurement resource set and a second measurement resource set, wherein the first measurement resource set and the second measurement resource set each include one or more interference measurement resources (IMRs);
measuring, for each IMR included in the first measurement resource set or the second measurement resource set, a cross-link interference (CLI) level associated with a downlink receive beam associated with one or more of a first transmission reception point (TRP) or a second TRP; and
transmitting, to the network node, a report that includes information related to the CLI level associated with each of the one or more IMRs included in the first measurement resource set and the second measurement resource set.

30. A method for wireless communication by a network node, comprising:
transmitting, to a user equipment (UE), a configuration that indicates a first measurement resource set and a second measurement resource set, wherein the first measurement resource set and the second measurement resource set each include one or more interference measurement resources (IMRs); and
receiving, from the UE, a report that includes information related to a cross-link interference (CLI) level associated with each of the one or more IMRs included in the first measurement resource set and the second measurement resource set for a first transmission reception point (TRP) or a second TRP.
